(19) United States
(12) Patent Application Publication
(10) Pub. No.: US 2026/0031940 A1
(43) Pub. Date: Jan. 29, 2026

(54) SIGNAL FIELD DESIGNS FOR ENHANCED LONG RANGE (ELR) TRANSMISSIONS

(71) Applicant: QUALCOMM Incorporated, San Diego, CA (US)

(72) Inventors: Lin YANG, San Diego, CA (US); Youhan KIM, Saratoga, CA (US); Bin TIAN, San Diego, CA (US); Tzu-Hsuan CHOU, San Diego, CA (US); Jialing Li CHEN, San Diego, CA (US)

(21) Appl. No.: 19/275,194

(22) Filed: Jul. 21, 2025

Related U.S. Application Data
(60) Provisional application No. 63/676,282, filed on Jul. 26, 2024.

(51) Int. Cl. H04L 5/00

(52) U.S. Cl. CPC H04L 5/0044

(57) ABSTRACT

This disclosure provides methods, components, devices and systems for signal field designs for enhanced long range (ELR) transmissions. Some aspects more specifically relate to universal-signal (U-SIG) field designs, and corresponding subfield interpretations, to facilitate a selective parsing at one or more wireless communication devices that receive a physical layer (PHY) protocol data unit (PPDU) associated with an ELR format. In some examples, a U-SIG field may include a first indication that the PPDU is associated with an ELR format and a second indication of a station (STA) identifier (ID) (STA-ID) of an addressed receiver of the PPDU. Some further aspects more specifically relate to ELR-signal (ELR-SIG) field designs within PPDUs associated with an ELR format to facilitate a parsing of ELR-data that follows an ELR-SIG field. Some further aspects more specifically relate to rate matching schemes associated with an ELR-data field within an ELR PPDU.

### CROSS REFERENCES

The present Application for Patent claims benefit of U.S. Provisional Patent Application No. 63/676,282 by YANG et al., entitled “SIGNAL FIELD DESIGNS FOR ENHANCED LONG RANGE (ELR) TRANSMISSIONS,” filed Jul. 26, 2024, assigned to the assignee hereof, and expressly incorporated herein.

### TECHNICAL FIELD

This disclosure relates generally to wireless communication and, more specifically, to signal field designs for enhanced long range (ELR) transmissions.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available network resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

In some wireless communication networks, one or more wireless communication devices, such as wireless STAs and/or wireless APs, may extend a distance, or coverage range, over which wireless coverage is provided. For example, the wireless communication devices may operate using a 2.4 gigahertz (GHz) frequency band rather than a 5 GHz or 6 GHz frequency band, because the 2.4 GHz band uses longer waves, which increases coverage range and provides more reliable transmission through objects. Such wireless communication networks may be referred to as long range (LR) wireless communication networks. In some WLANs, the wireless communication devices may transmit a physical layer (PHY) protocol data unit (PPDU) to an intended receiver. The PPDU may include a preamble portion and a data portion. One or more select fields of the preamble portion may indicate one or more of a format, a version, or a mode associated with the PPDU and the data portion may carry a data payload in accordance with the indicated format, version, or mode. The wireless communication device may generate and transmit the PPDU in accordance with one of various formats. For example, depending on a capability of the wireless communication device, the wireless communication device may transmit the PPDU in accordance with an extremely high throughput (EHT) format, an ultra-high reliability (UHR) format, or an enhanced long range (ELR) format.

### SUMMARY

The systems, methods, and devices of this disclosure each have several innovative aspects, no single one of which is solely responsible for the desirable attributes disclosed herein.

One innovative aspect of the subject matter described in this disclosure can be implemented in an apparatus for wireless communications at a wireless communication device. The apparatus may include a processing system that includes processor circuitry and memory circuitry that stores code. The processing system may be configured to cause the apparatus to receive, via a version independent portion of a universal signal (U-SIG) field of a physical layer (PHY) protocol data unit (PPDU), a version identifier subfield indicative of a version associated with the PPDU and parse a version dependent portion of the U-SIG field of the PPDU in accordance with the version associated with the PPDU, the version dependent portion of the U-SIG field including at least a first indication that the PPDU is associated with an enhanced long range (ELR) format and a second indication of a first station (STA) identifier associated with the PPDU.

Another innovative aspect of the subject matter described in this disclosure can be implemented in a method for wireless communication by or at wireless communication device. The method may include receiving, via a version independent portion of a U-SIG field of a PPDU, a version identifier subfield indicative of a version associated with the PPDU and parsing a version dependent portion of the U-SIG field of the PPDU in accordance with the version associated with the PPDU, the version dependent portion of the U-SIG field including at least a first indication that the PPDU is associated with an ELR format and a second indication of a first STA identifier associated with the PPDU.

Another innovative aspect of the subject matter described in this disclosure can be implemented in an apparatus for wireless communications at a wireless communication device. The apparatus may include means for receiving, via a version independent portion of a U-SIG field of a PPDU, a version identifier subfield indicative of a version associated with the PPDU and means for parsing a version dependent portion of the U-SIG field of the PPDU in accordance with the version associated with the PPDU, the version dependent portion of the U-SIG field including at least a first indication that the PPDU is associated with an ELR format and a second indication of a first STA identifier associated with the PPDU.

Another innovative aspect of the subject matter described in this disclosure can be implemented in a non-transitory computer-readable medium storing code for wireless communication by an apparatus at or of a wireless communication device. The code may include instructions executable by one or more processors to receive, via a version independent portion of a U-SIG field of a PPDU, a version identifier subfield indicative of a version associated with the PPDU and parse a version dependent portion of the U-SIG field of the PPDU in accordance with the version associated with the PPDU, the version dependent portion of the U-SIG field including at least a first indication that the PPDU is associated with an ELR format and a second indication of a first STA identifier associated with the PPDU.

In some implementations of the method, apparatuses, wireless communication devices, and non-transitory computer-readable medium described herein, the version dependent portion of the U-SIG field includes a PPDU type and compression mode subfield and the PPDU type and compression mode subfield includes the first indication that the PPDU may be associated with the ELR format in accordance with the version associated with the PPDU.

In some implementations of the method, apparatuses, wireless communication devices, and non-transitory computer-readable medium described herein, the version dependent portion of the U-SIG field includes an ELR subfield in accordance with the version associated with the PPDU and the ELR subfield includes the first indication that the PPDU may be associated with the ELR format.

In some implementations of the method, apparatuses, wireless communication devices, and non-transitory computer-readable medium described herein, the version dependent portion of the U-SIG field includes a validate bit and the first indication that the PPDU may be associated with the ELR format corresponds to a value of the validate bit.

In some implementations of the method, apparatuses, wireless communication devices, and non-transitory computer-readable medium described herein, the version dependent portion of the U-SIG field includes a STA identifier subfield in accordance with the version associated with the PPDU, the STA identifier subfield includes the second indication of the first STA identifier associated with the PPDU, and the first STA identifier corresponds to an addressed receiver of the PPDU.

Another innovative aspect of the subject matter described in this disclosure can be implemented in an apparatus for wireless communications at a wireless communication device. The apparatus may include a processing system that includes processor circuitry and memory circuitry that stores code. The processing system may be configured to cause the apparatus to receive, via a preamble portion of a PPDU associated with an ELR format, an ELR-signal (ELR-SIG) field that includes two symbols, the two symbols collectively including a first set of multiple subfields that includes at least a modulation and coding scheme (MCS) subfield and a coding subfield associated with a data portion of the PPDU and a second set of multiple subfields that follows the first set of multiple subfields and that includes at least a cyclic redundancy check (CRC) subfield and a tail subfield and receive, via the data portion of the PPDU, an ELR-data field in accordance with at least the MCS subfield and the coding subfield.

Another innovative aspect of the subject matter described in this disclosure can be implemented in a method for wireless communication by or at wireless communication device. The method may include receiving, via a preamble portion of a PPDU associated with an ELR format, an ELR-SIG field that includes two symbols, the two symbols collectively including a first set of multiple subfields that includes at least an MCS subfield and a coding subfield associated with a data portion of the PPDU and a second set of multiple subfields that follows the first set of multiple subfields and that includes at least a CRC subfield and a tail subfield and receiving, via the data portion of the PPDU, an ELR-data field in accordance with at least the MCS subfield and the coding subfield.

Another innovative aspect of the subject matter described in this disclosure can be implemented in an apparatus for wireless communications at a wireless communication device. The apparatus may include means for receiving, via a preamble portion of a PPDU associated with an ELR format, an ELR-SIG field that includes two symbols, the two symbols collectively including a first set of multiple subfields that includes at least an MCS subfield and a coding subfield associated with a data portion of the PPDU and a second set of multiple subfields that follows the first set of multiple subfields and that includes at least a CRC subfield and a tail subfield and means for receiving, via the data portion of the PPDU, an ELR-data field in accordance with at least the MCS subfield and the coding subfield.

Another innovative aspect of the subject matter described in this disclosure can be implemented in a non-transitory computer-readable medium storing code for wireless communication by an apparatus at a wireless communication device. The code may include instructions executable by one or more processors to receive, via a preamble portion of a PPDU associated with an ELR format, an ELR-SIG field that includes two symbols, the two symbols collectively including a first set of multiple subfields that includes at least an MCS subfield and a coding subfield associated with a data portion of the PPDU and a second set of multiple subfields that follows the first set of multiple subfields and that includes at least a CRC subfield and a tail subfield and receive, via the data portion of the PPDU, an ELR-data field in accordance with at least the MCS subfield and the coding subfield.

Some implementations of the method, apparatuses, wireless communication devices, and non-transitory computer-readable medium described herein may further include operations, features, means, or instructions for parsing the ELR-data field in accordance with information indicated by the MCS subfield and the coding subfield.

In some implementations of the method, apparatuses, wireless communication devices, and non-transitory computer-readable medium described herein, the first set of multiple subfields further includes a STA identifier subfield indicative of at least a portion of a first STA identifier associated with the PPDU, the first STA identifier corresponds to an addressed receiver of the PPDU, and the wireless communication device parses the ELR-data field in accordance with at least a portion of a second STA identifier associated with the wireless communication device matching at least the portion of the first STA identifier associated with the PPDU.

In some implementations of the method, apparatuses, wireless communication devices, and non-transitory computer-readable medium described herein, the two symbols of the ELR-SIG field include a first symbol and a second symbol and the method, apparatuses, and non-transitory computer-readable medium may include further operations, features, means, or instructions for decoding the first symbol and the second symbol separately, the first symbol including the first set of multiple subfields and the second symbol including the second set of multiple subfields.

In some implementations of the method, apparatuses, wireless communication devices, and non-transitory computer-readable medium described herein, decoding the first symbol and the second symbol separately may include operations, features, means, or instructions for decoding the first symbol of the ELR-SIG field in accordance with a first set of multiple CRC bits within the first symbol and decoding the second symbol of the ELR-SIG field in accordance with a second set of multiple CRC bits within the second symbol.

In some implementations of the method, apparatuses, wireless communication devices, and non-transitory computer-readable medium described herein, decoding the first symbol and the second symbol separately may include operations, features, means, or instructions for decoding the first symbol of the ELR-SIG field in accordance with a set of multiple CRC bits within the second symbol and decoding the second symbol of the ELR-SIG field in accordance with the set of multiple CRC bits within the second symbol.

Some implementations of the method, apparatuses, wireless communication devices, and non-transitory computer-readable medium described herein may further include operations, features, means, or instructions for decoding the two symbols of the ELR-SIG field jointly to obtain the first set of multiple subfields and the second set of multiple subfields.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIGS. 4A and 4B show example universal signal (U-SIG) field designs associated with some example PPDU formats.

FIG. 5 shows an example enhanced long range (ELR) PPDU format that supports signal field designs for ELR transmissions.

FIG. 6 shows an example signaling diagram that illustrates communication of an ELR PPDU between two wireless communication devices.

FIGS. 7A, 7B, and 8 show example ELR U-SIG field designs that support signal field designs for ELR transmissions by including or conveying a first indication that a PPDU is associated with an ELR format and a second indication of a STA identifier (ID) (STA-ID) of an addressed receiver of the PPDU.

FIGS. 9A and 9B show example one-symbol ELR-signal (ELR-SIG) field designs that support signal field designs for ELR transmissions.

FIGS. 10A, 10B, 11A, 11B, and 12 show example two-symbol ELR-SIG field designs with separately encoded symbols that support signal field designs for ELR transmissions.

FIGS. 13A, 13B, and 14 show example two-symbol ELR-SIG field designs with jointly encoded symbols that support signal field designs for ELR transmissions.

FIGS. 15-19 show example rate matching schemes associated with an ELR-data field of an ELR PPDU.

FIG. 20 shows a block diagram of an example wireless communication device that supports signal field designs for ELR transmissions.

FIGS. 21-24 show flowcharts illustrating example processes performable by or at a wireless communication device that supports signal field designs for ELR transmissions.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, one or more communication devices (such as wireless stations (STAs), wireless access points (APs), or both) may extend a distance, or coverage range, over which wireless communication is provided. For example, the communication devices may operate using a 2.4 gigahertz (GHz) frequency band rather than a 5 GHz or 6 GHz frequency band, because the 2.4 GHZ band uses longer waves, which increases range and provides more reliable transmission through objects. Such wireless communication networks may be referred to as long range (LR) wireless communication networks. The existing LR wireless packet design may cover single carrier-based LR mods in a 2.4 GHz frequency band (for example, 802.11b wireless communication protocols), an extended range (ER) single user mode (for example, an orthogonal frequency division multiplexed (OFDM)-based ER mode, or 802.11ax wireless communication protocols), or both. The LR wireless communication networks may be outdoor IOT networks and indoor networks with longer range conditions. The wireless communication devices may be wireless video doorbells, outdoor surveillance cameras, wireless garage door controllers, outdoor sprinkler controllers, wireless speakers, smart appliances, security IOT devices, or any combination thereof. However, one or more communication devices may still be outside of this long range. Further, the data rate of the communications in the LR wireless communication network may be relatively low due to slower transmission time using longer waves, which may cause latency and relatively low throughput as compared to a network that uses a higher frequency band.

One or more wireless communication devices may increase the data rate, the range, or both for LR wireless communication networks, which may correspondingly be referred to as enhanced long range (ELR) networks. The wireless communication devices may implement an ELR wireless packet design to obtain a target data rate while maintaining or increasing an existing coverage range of an LR wireless communication network, where the coverage range is the geographical area within which the wireless communication devices may transmit and receive signaling. Additionally, or alternatively, the wireless communication devices may implement an ELR wireless packet design to extend a coverage range while maintaining a similar, or slightly lower, data rate as compared to a coverage range of an LR wireless communications network. In some implementations, the wireless communication devices may implement an ELR wireless packet design to extend a coverage range and reduce an uplink and downlink power imbalance due to, for example, one or more regulations and/or hardware differences at uplink and downlink devices.

In some wireless communication networks, a wireless communication device may transmit a physical layer (PHY) protocol data unit (PPDU) to an intended receiver. The PPDU may include a preamble portion and a data portion. One or more select fields of the preamble portion may indicate one or more of a format, a version, or a mode associated with the PPDU and the data portion may carry a data payload in accordance with the indicated format, version, or mode. The wireless communication device, which may be an AP or a STA, may generate and transmit the PPDU in accordance with one of various formats. For example, depending on a capability of the wireless communication device, the wireless communication device may transmit the PPDU in accordance with an extremely high throughput (EHT) format or an ultra-high reliability (UHR) format, among other examples. In some networks, a wireless communication device may support ELR transmissions, which may extend a coverage associated with the wireless communication device (and which may be equivalently referred to herein as “extended” long range transmissions). The ELR transmissions may be associated with a dedicated PPDU format to facilitate use of a relatively higher transmit power or to otherwise increase a range of the PPDU.

Based on the greater communication range associated with ELR transmissions, a relatively large quantity of devices within a network may “hear” or detect an ELR PPDU, including both devices relatively near to a transmitting device and devices relatively far from the transmitting device. To avoid causing unnecessary power consumption due to PPDU parsing at “overhearing” devices that are not the intended receiver of a PPDU, the transmitting device may include information relatively early within the PPDU (such as within a preamble portion) to facilitate an “early drop” of the PPDU at unintended receivers. Different fields of a preamble portion of an ELR PPDU, however, may be associated with different amounts of power boosting, such that receiving devices may acquire different information depending on a proximity to the transmitting device. In such scenarios, various wireless communication devices may benefit from additional ELR signaling mechanisms (such as protocols, formats, or designs) to facilitate an “early drop” at various points throughout a preamble of an ELR PPDU, such as within a universal-signal (U-SIG) field of the ELR PPDU. Further, ELR PPDUs may lack a time gap between an ELR-signal (ELR-SIG) and an ELR-data field, which may complicate receive-side preparation associated with data demodulation and decoding. For example, in accordance with some ELR PPDU formats, a receiving device may be expected to perform data demodulation and decoding within one symbol of receiving information indicative of a modulation and coding scheme (MCS) and a coding of the ELR-data. Thus, various wireless communication devices also may benefit from ELR-SIG field designs that assist or otherwise facilitate receive-side preparation associated with ELR-data demodulation and decoding.

Various aspects relate generally to signal field designs for ELR transmissions. Some aspects more specifically relate to U-SIG field designs, and corresponding subfield interpretations, to facilitate a selective parsing at one or more wireless communication devices that receive a PPDU associated with an ELR format. In some examples, a wireless communication device may format the U-SIG field within a preamble portion of a PPDU to include a first indication that the PPDU is associated with an ELR format and to include a second indication of a STA identifier (ID) (STA-ID) associated with an intended/addressed receiver of the PPDU. In some implementations, a value of an ELR subfield within a version dependent portion of the U-SIG field may convey the first indication. Additionally, or alternatively, a value of a PPDU type and compression mode subfield within the version dependent portion of the U-SIG field may convey the first indication. Additionally, or alternatively, a value of at least one validate bit within the version dependent portion of the U-SIG field may convey the first indication. Further, in some implementations, a STA-ID subfield within the version dependent portion of the U-SIG may convey the second indication. In some examples, the version dependent portion of the U-SIG field may include the first indication or the second indication, or both, in accordance with a version of the U-SIG field, such as a version indicated by a PHY version identifier subfield within a version independent portion of the U-SIG field.

Some further aspects relate to ELR-SIG field designs within PPDUs associated with an ELR format to facilitate a parsing of ELR-data that follows an ELR-SIG field. In some examples, a wireless communication device may format an ELR-SIG field to include or span one symbol. In such examples, the wireless communication device may include, within the ELR-SIG field, control information that is relatively more useful for demodulating and decoding the ELR-data that follows the ELR-SIG field. In some other examples, the wireless communication device may format an ELR-SIG field to include or span two symbols, which the wireless communication device may encode separately or jointly. In such examples, the two symbols may collectively include at least a first set of subfields and a second set of subfields. The second set of subfields may follow (such as be subsequent to) the first set of subfields. In some implementations, the first set of subfields may include the control information that is relatively more useful for demodulating and decoding the ELR-data that follows the ELR-SIG field (to facilitate receive-side preparation within the second set of subfields, such as while parsing the second set of subfields). For example, the first set of subfields may include at least an MCS subfield and a coding subfield. In examples in which the two symbols of the ELR-SIG field are separately encoded, a first symbol may include the first set of subfields, and a second symbol may include the second set of subfields.

Some further aspects relate to rate matching schemes associated with an ELR-data field within an ELR PPDU. In some examples, an ELR-SIG field may include one or both of a low-density parity-check (LDPC) extra symbol segment subfield and a (common) pre-forward error correction (FEC) padding factor subfield. In such examples, a transmitting wireless communication device may generate (such as encode and modulate) the ELR-data field in accordance with the information indicated by one or both of the LDPC extra symbol segment subfield and the pre-FEC padding factor subfield. Likewise, a receiving wireless communication device may parse (such as demodulate and decode) the ELR-data field in accordance with the information indicated by one or both of the LDPC extra symbol segment subfield and the pre-FEC padding factor subfield. Additionally, or alternatively, ELR rate matching may be associated with one or more fixed or static values. In such implementations, an ELR-SIG field may exclude one or both of the LDPC extra symbol segment subfield and the pre-FEC padding factor subfield. In such examples, a transmitting wireless communication device and a receiving wireless communication device may generate and parse, respectively, the ELR-data field in accordance with the one or more fixed or static values.

Particular aspects of the subject matter described in this disclosure can be implemented to realize one or more of the following potential advantages. In some examples, by including, within a U-SIG field of a PPDU, a first indication that the PPDU is associated with an ELR format and a second indication of a STA-ID associated with (such as corresponding to) an intended receiver of the PPDU, the described techniques can be used to enable one or more unintended receiving devices to perform an “early drop” of the PPDU. For example, a non-ELR-capable receiving device may terminate a parsing procedure (such as a receiving or parsing process) in accordance with receiving the first indication and an ELR-capable but unintended receiving device may terminate a parsing procedure in accordance with receiving the second indication (as the ELR-capable device may continue parsing past the first indication in accordance with having a matching capability). By enabling unintended or non-ELR-capable devices to terminate a parsing process associated with a detected/received PPDU, such devices may experience less power consumption and longer battery lives, among other benefits.

Additionally, by formatting an ELR-SIG field of an ELR PPDU to provide (relatively early within the ELR-SIG field) relatively more useful information for demodulating and decoding the ELR-data that follows the ELR-SIG field, a receiving device may have more time to prepare one or more components associated with data reception processing at the receiving device. In other words, the disclosed ELR-SIG field designs may enable a receiving device to switch or configure one or more components in accordance with an indicated MCS and coding associated with the ELR-data prior to a start of an ELR-data field, which may result in a greater likelihood of successful demodulation and decoding at the receiving device. For example, the receiving device may experience or measure a greater signal quality, and accordingly an extended range, in accordance with properly preparing for ELR-data reception. In accordance with such a greater likelihood of successful demodulation and decoding, implementing networks may experience higher data rates, greater spectral efficiency, and greater system capacity, among other benefits.

Moreover, by utilizing one or more of the disclosed rate matching schemes associated with the ELR-data field, communicating devices may similarly achieve greater signal quality and extended range by efficiently achieving a target data rate with a target reliability, such as by efficiently adapting an output data rate of a channel encoder to match the available resources allocated for a transmission of an ELR PPDU. Further, in accordance with the disclosed rate matching schemes, wireless communication devices may dynamically, selectively, or conditionally include or exclude subfields related to rate matching within an ELR-SIG field, which the wireless communication devices may leverage to balance dynamic network adaptation in terms of rate matching with ELR-SIG field signaling overhead. In accordance with achieving such greater signal quality and extended range, the described disclosed rate matching schemes also can be further implemented to realize higher data rates, greater spectral efficiency, and greater system capacity, among other benefits.

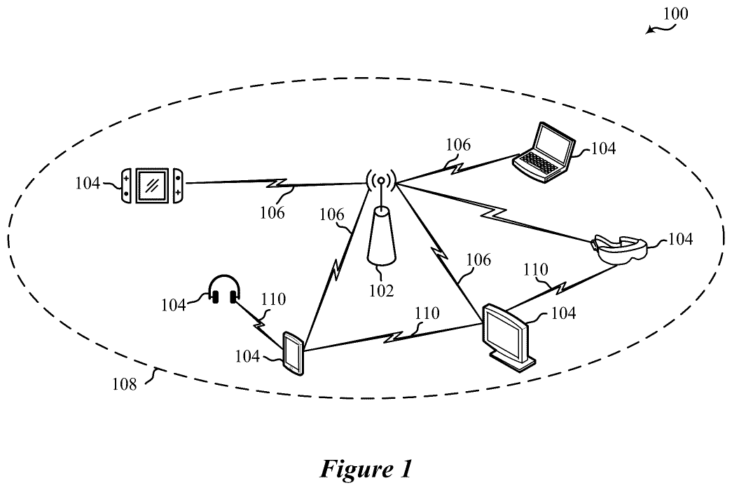

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless AP 102 and any number of wireless STAs 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (cNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IOT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHZ, 6 GH2, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PPDUs.

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHZ-7.125 GHZ), FR2 (24.25 GHZ-52.6 GHZ), FR3 (7.125 GHz-24.25 GHZ), FR4a or FR4-1 (52.6 GHz-71 GHZ), FR4 (52.6 GHz-114.25 GHZ), and FR5 (114.25 GHZ-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHZ, 160 MHZ, 240 MHZ, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel.

Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

In some implementations, an AP 102 or a STA 104 may support one or more signaling- or configuration-based mechanisms according to which the AP 102 or the STA 104 may transmit or receive one or more PPDUs associated with an ELR format. An AP 102 or a STA 104 may perform an ELR transmission to increase a coverage range of the AP 102 or the STA 104. For example, the AP 102 or the STA 104 may power boost one or more portions (such as one or more fields) of a PPDU associated with an ELR format to facilitate longer range communication. Additionally, or alternatively, the AP 102 or the STA 104 may modulate or leverage a resource allocation scheme to facilitate longer range communication.

In some aspects, the AP 102 or the STA 104 may support one or more signaling designs or field/subfield interpretations, or both, to enable or facilitate a selective parsing at one or more receiving devices. For example, in association with transmitting a PPDU in a manner that facilitates longer range communication, relatively more devices may receive or detect the PPDU. To avoid causing unnecessary power consumption (due to, for example, parsing operations) across such a relatively larger quantity of potential receiving devices, wireless communication devices (such as one or more APs 102 or one or more STAs 104, or any combination thereof) within the wireless communication network 100 may employ signaling designs or field/subfield interpretations, or both, to facilitate mechanisms according to which a receiving device may stop (such as cease, suspend, pause, terminate, or cancel) parsing a received PPDU at a relatively early stage if the PPDU is not intended for that receiving device.

Additionally, or alternatively, the AP 102 or the STA 104 may support one or more signaling designs or field/subfield interpretations, or both, to provide information usable to parse one or more ELR-data fields, such as information associated with an MCS, a coding, or a rate matching scheme, or any combination thereof. Further, in accordance with some example implementations, two or more wireless communication devices may exchange (such as transmit or receive) one or more of capability signaling, configuration signaling, or activation/deactivation signaling associated with one or more of the example signaling designs, formats, or field/subfield interpretations disclosed herein. As described herein, a wireless communication device may be any communication device capable of wireless communication in addition to, or as an alternative from, wired communication.

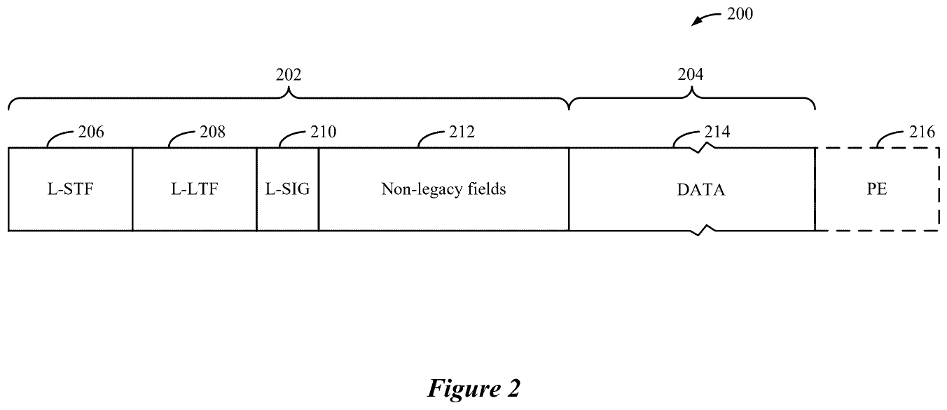

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

In some implementations, the one or more non-legacy fields 212 may include a U-SIG field, an ELR field (such as an ELR-mark field) including one or more ELR symbols (such as one or more ELR-mark symbols), an ELR-STF (which may sometimes be referred to as an ELR-STF field), an ELR-LTF (which may sometimes be referred to as an ELR-LTF field), and an ELR-SIG field. In such implementations, the data field 214 may be an example of an ELR-data field. A transmitting wireless communication device, such as an AP 102 or a STA 104, may generate the PDU 200 to include one or more of the U-SIG field, the ELR field, the ELR-STF field, the ELR-LTF field, and the ELR-SIG field in association with formatting the PDU 200 in accordance with an ELR format, such as an ELR PPDU format.

Further, in some implementations, the PDU 200 may include a packet extension (PE) field 216. The PE field 216 may be part of the PHY payload 204 or may be after the PHY payload 204. A transmitting device may optionally include the PE field within the PDU 200. In some aspects, the PE field 216 may be associated with a fixed or static length or size. For example, the PE field 216 may be associated with a fixed PE value (which may be indicated by an ELR-SIG field, if included).

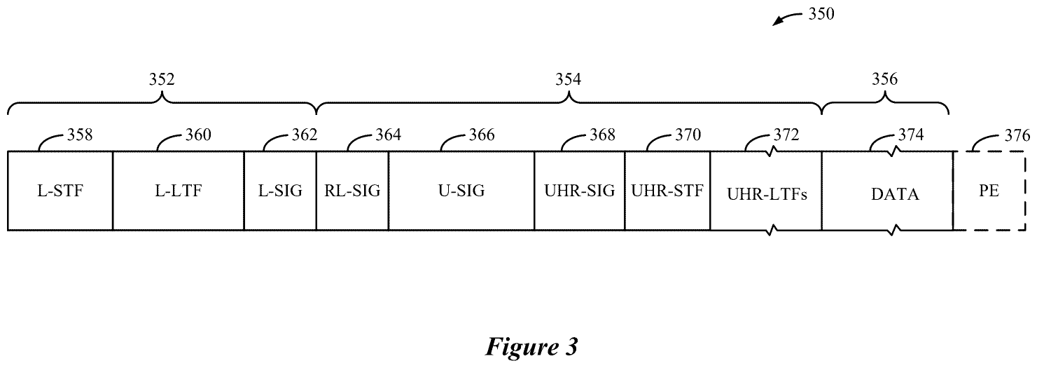

FIG. 3 shows an example PPDU 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364, a universal signal field (referred to herein as “U-SIG 366”) and a UHR signal field (referred to herein as “UHR-SIG 368”). The presence of RL-SIG 364 and U-SIG 366 may indicate to UHR or later version-compliant STAs 104 that the PPDU 350 is a UHR PPDU or a PPDU conforming to any later (post-UHR) version of a new wireless communication protocol conforming to a future IEEE 802.11 wireless communication protocol standard. One or both of U-SIG 366 and UHR-SIG 368 may be structured as, and carry version-dependent information for, other wireless communication protocol versions associated with amendments to the IEEE family of standards beyond UHR. For example, U-SIG 366 may be used by a receiving device (such as an AP 102 or a STA 104) to interpret bits in one or more of UHR-SIG 368 or the data field 374. U-SIG 366 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication). The version-dependent fields may include format information fields used for interpreting other fields of U-SIG 366 and UHR-SIG 368 and additional information fields or single user (SU)-specific fields that may be useful to intended recipients. In some implementations, the version-dependent fields may include at least a PPDU format field to indicate a general PPDU format for the PPDU 350 (such as a trigger-based (TB), a single-user (SU), or a multi-user (MU) PPDU format). Like L-STF 358, L-LTF 360, and L-SIG 362, the information in U-SIG 366 and UHR-SIG 368 may be duplicated and transmitted in each of the component 20 MHz channels in instances involving the use of a bonded channel.

The non-legacy portion 354 further includes an additional short training field (referred to herein as “UHR-STF 370,” although it may be structured as, and carry version-dependent information for, other wireless communication protocol versions beyond UHR) and one or more additional long training fields (referred to herein as “UHR-LTFs 372,” although they may be structured as, and carry version-dependent information for, other wireless communication protocol versions beyond UHR). UHR-STF 370 may be used for timing and frequency tracking and AGC, and UHR-LTF 372 may be used for more refined channel estimation.

UHR-SIG 368 may be used by an AP 102 to identify and inform one or multiple STAs 104 that the AP 102 has scheduled uplink (UL) or downlink (DL) resources for them. UHR-SIG 368 may be decoded by each compatible STA 104 served by the AP 102. UHR-SIG 368 also may generally be used by the receiving device to interpret bits in the data field 374. For example, UHR-SIG 368 may include resource unit (RU) allocation information, spatial stream configuration information, and per-user (such as STA-specific) signaling information. Each UHR-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some wireless communication networks, a STA 104 or an AP 102 may transmit the PPDU 350 over bandwidths larger than the 20 MHz, 40 MHZ, 80 MHZ, 160 MHz, and 320 MHz bandwidths supported by previous generations of IEEE-compliant wireless communication systems. For example, the PPDU 350 may support 480 MHz or 640 MHz bandwidth communications. By increasing the channel bandwidth of the PPDU 350 to 480 MHz or 640 MHz, more data may be transmitted because more or larger RUs are available based on the larger bandwidth, and accordingly, higher peak throughput or increased capacity may be achieved. Parameters for assembling and transmitting the 480 MHz or 640 MHz PPDUs may be defined to account for the larger bandwidths. For example, parameters or designs such as the tone plans, resource unit allocation indications, spatial reuse fields, UHR-STFs 370, UHR-LTFs 372, pilot signal locations, phase shifts, and spectral masks may be optimized or otherwise selected in accordance with the 480 MHz or 640 MHz bandwidths. In some examples, the spatial reuse fields may enable multiple BSSs to operate on the same 480 MHz or 640 MHz bandwidth channels.

In some examples, UHR-capable STAs 104 and APs 102 may support unequal modulation techniques (also referred to as unequal quadrature amplitude modulation (QAM)) with joint encoding across multiple streams for MIMO communications. For example, while different data streams may be transmitted using different spatial streams, or different resource units (RUs), or both, different spatial streams or RUs may be associated with different levels of quality (such as a different signal to noise ratios (SNRs)), and it may be advantageous to use different (unequal) MCSs for different spatial streams or RUs.

To support unequal modulation, an AP 102 may transmit signaling that indicates unequal MCSs across spatial streams or RUs to multiple STAs 104. For example, the AP 102 may transmit an MCS configuration message, which may be an example of a PHY preamble included in control signaling for PHY layer configuration, to indicate the unequal MCSs. In some examples, an MCS field of the MCS configuration message may include entries for unequal QAM schemes across multiple spatial streams, where the multiple spatial streams may be encoding with the same code rate.

In some wireless communication systems, wireless communication devices may support low density parity check (LDPC) coding for forward error correcting purposes to increase the likelihood of accurate data transmission. In some examples, UHR-capable STAs 104 and APs 102 may be capable of selecting among multiple LDPC codeword lengths, including 648 bits, 1296 bits and 1944 bits (defined in legacy IEEE 802.11 wireless communications protocol standards), as well as even longer (extended) codeword lengths, which may increase as operating bandwidths increase, higher modulation orders are introduced, or more spatial streams are available. Using longer LDPC codewords may achieve lower block error rates in some channels, such as channels associated with additive white Gaussian noise. Longer LDPC codewords also may enable more reliable communications in channels with lower SNRs. To facilitate the use of multiple LDPC codeword lengths, a STA 104 and an AP 102 may each include multiple LDPC encoders and multiple LDPC decoders. In some examples, such a STA 104 or AP 102 may connect, aggregate or otherwise utilize multiple encoders to implement a larger single encoder capable of encoding a longer codeword, or similarly, utilize multiple decoders to implement a larger single decoder capable of decoding a longer codeword, which may increase performance gains associated with larger block sizes without substantially increasing the hardware cost or complexity. In some examples, to generate an extended LDPC codeword, a STA 104 or an AP 102 may implement one or more lifting operations to extend a shorter codeword, with each lifting operation extending the previously lifted codeword. A “lifting” operation enables LDPC codes to be implemented using parallel encoding or decoding implementations while also reducing the complexity typically associated with large LDPC codewords. In some examples, a STA 104 or an AP 102 may use mixed codeword lengths for a given transmission. For example, the STA 104 or the AP 102 may encode input bits into one or more codewords having a first, longer codeword length (more than 1944 bits) and one or more codewords having a second, shorter codeword length (1944 bits or less). In such examples, the STA 104 or the AP 102 may perform shortening or puncturing on the codewords having the longer codeword length, or on the codewords having the shorter codeword length, or both.

To support increased range or rate-over-range, a STA 104 and an AP 102 may support ELR PPDU formats. The use of an ELR PPDU format can enable the achievement of a target data rate while maintaining an existing coverage range, reduce an uplink/downlink power imbalance (due to, for example, one or more regulations or hardware differences at the uplink and downlink devices), or extend a coverage range while maintaining a similar, or slightly lower, data rate as compared with other PPDU formats. In some examples, an ELR PPDU may be transmitted over a narrow bandwidth, which may have a lower noise floor and thus higher SNR, thereby extending the coverage range. The reliability of the transmission of an ELR PPDU also may be increased as a result of using various optimized coding rates, coded bit repetition schemes, or duplication schemes, which may provide for improved decodability and fewer retransmissions. In some examples, the U-SIG 366 of an ELR PPDU 350 may include a first indication (such as a codepoint of a PHY version identifier subfield within a version-independent portion of the U-SIG 366 or a value of an ELR subfield within a version-dependent portion of the U-SIG 366) that the PPDU 350 is associated with an ELR format. The U-SIG 366 of an ELR PPDU 350 may include a second indication (such as a STA identifier subfield within the version-dependent portion of the U-SIG 366) of an intended receiver of the PPDU. In some examples, an ELR PPDU 350 may include an ELR-SIG field that includes an uplink/downlink indicator subfield, a length subfield, a coding indicator subfield, and an MCS subfield.

In some wireless communication systems, wireless communication between an AP 102 and an associated STA 104 can be secured. For example, cither an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (such as APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

In some aspects, the wireless communication device may indicate a format of a PPDU via a PHY version identifier subfield of a U-SIG field, such as the U-SIG 366. For example, in some implementations, a first codepoint (such as a “0” value as denoted by, for example, “000” codepoint) of the PHY version identifier subfield may indicate that the PPDU 350 is associated with the EHT format (such as an EHT version). A second codepoint (such as a “1” value as denoted by, for example, a “001” codepoint) of the PHY version identifier subfield may indicate that a PPDU is associated with a UHR format (such as a UHR version). In some aspects, the second codepoint may indicate that the PPDU is associated with a UHR format or an ELR format (such as a UHR ELR format or version). Alternatively, a third codepoint (such as a “2” value as denoted by, for example, a “010” codepoint, or such as a “7” value as denoted by, for example, a “111” codepoint) of the PHY version identifier subfield may indicate that the PPDU is associated with an ELR format (such as an ELR version).

Further, in some implementations, the PPDU 350 may include a PE field 376. The PE field 376 may be part of the payload 356 or may be after the payload 356. A transmitting device may optionally include the PE field within the PPDU 350. In some aspects, the PE field 376 may be associated with a fixed or static length or size. For example, the PE field 376 may be associated with a fixed PE value (which may be indicated by an ELR-SIG field, if included).

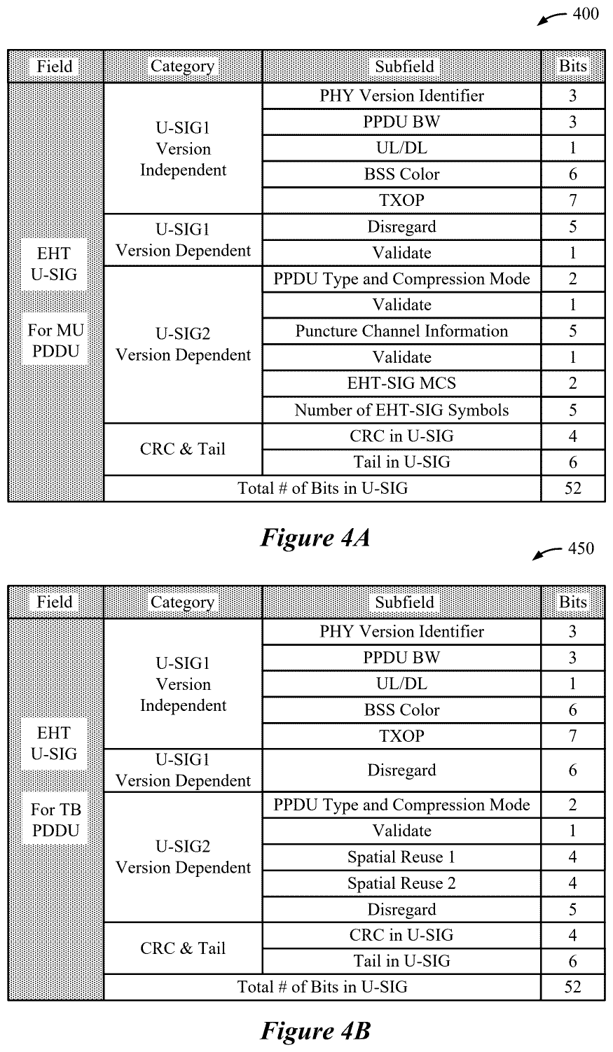

FIGS. 4A and 4B show example U-SIG field designs 400 and 450, respectively, that support signal field designs for ELR transmissions. For example, the U-SIG field designs 400 and 450 may be associated with an EHT PPDU format and a wireless communication device (such as a STA 104 or an AP 102) may include a U-SIG field associated with the U-SIG field design 400 or the U-SIG field design 450 within an EHT PPDU. A wireless communication device may generate and include a U-SIG field associated with the U-SIG field design 400 for an MU PPDU. A wireless communication device may generate and include a U-SIG field associated with the U-SIG field design 450 for a trigger-based (TB) PPDU.

The U-SIG field designs 400 and 450 may be associated with (such as include) a version independent portion and a version dependent portion and one or more symbols (such as two symbols, which may be denoted as U-SIG1 and U-SIG2). The version independent portion may include one or more version independent fields (such as fields that are included within a U-SIG field regardless of the version or format of the U-SIG field or of the PPDU carrying the U-SIG field) and the version dependent portion may include one or more version dependent fields (such as fields that are conditionally, selectively, or optionally included within a U-SIG field depending on the version or format of the U-SIG field or of the PPDU carrying the U-SIG field).

For example, the version independent portion of the U-SIG field designs 400 and 450 may include a PHY version identifier subfield of 3 bits, a PPDU bandwidth (BW) subfield of 3 bits, an uplink/downlink indicator subfield (which may be equivalently referred to herein as an “UL/DL subfield”) of 1 bit, a BSS color subfield of 6 bits, and a transmission opportunity (TXOP) subfield of 7 bits. Additionally, both the -SIG field designs 400 and 450 may be associated with (such as include) a cyclic redundancy check (CRC) and tail portion, which may include a CRC subfield of 4 bits and a tail subfield of 6 bits in both the U-SIG field designs 400 and 450. Further, both the U-SIG field designs 400 and 450 may be associated with (such as include or occupy) 52 bits in total.

The version dependent portion of the U-SIG field design 400 (associated with the MU PPDU format) may include a disregard subfield of 5 bits, a validate subfield of 1 bit, a PPDU type and compression mode subfield of 2 bits, a validate subfield of 1 bit, a puncture channel information subfield of 5 bits, a validate subfield of 1 bit, an EHT-SIG MCS subfield of 2 bits, and a number of EHT-SIG symbols subfield (such as a length subfield) of 2 bits. The version dependent portion of the U-SIG field design 450 (associated with the TB PPDU format) may include a disregard subfield of 6 bits, a PPDU type and compression mode subfield of 2 bits, a validate subfield of 1 bit, a first spatial reuse subfield of 4 bits, a second spatial reuse subfield of 4 bits, and a disregard subfield of 5 bits.

In accordance with the U-SIG field designs 400 and 450, a U-SIG1 field (such as a first U-SIG symbol) may lack available bits to provide, carry, or indicate a full STA-ID (which may correspond to 11 bits). The version independent field or portion of a U-SIG field may include or occupy 20 bits, and the CRC and tail subfields may include or occupy 10 bits such that, in some networks, 52−30=22 bits may be usable in a U-SIG field to accommodate or provide UHR or ELR dependent information bits.

In some example implementations, one or more wireless communication devices may support one or more updated U-SIG field designs associated with (such as to support) additional versions or formats of the U-SIG field or of the PPDU carrying the U-SIG field. For example, one or more wireless communication devices may support one or more U-SIG field designs associated with ELR communication, such as U-SIG field designs associated with PPDUs that are associated with an ELR format (such as ELR PPDU formats). In such examples, one or more wireless communication devices may support one or more additional or replacing subfields or one or more additional or replacing subfield interpretations, or both.

Further, in some examples, a transmitting device and a receiving device may leverage (such as use or employ) such one or more additional or replacing subfields or one or more additional or replacing subfield interpretations, or both, to enable a selective (such as conditional) parsing of the PPDU at the receiving device. Such a selective parsing may include a continuation of a parsing of the PPDU or a dropping of the PPDU (which may be referred to herein as an “early drop” of the PPDU and which may involve a termination of a parsing process at the receiving device). For example, an EHT/UHR capable device that is non-ELR capable may rely on or use U-SIG content to defer or drop power from an ELR packet. For further example, for an ELR capable device, if the received SNR satisfies (such as is greater than) a packet detection (PD) threshold such that the device detects the U-SIG, the device may use U-SIG content such as a STA-ID to assist with an early drop determination, which increase device and network power savings/efficiency and provide a greater user experience.

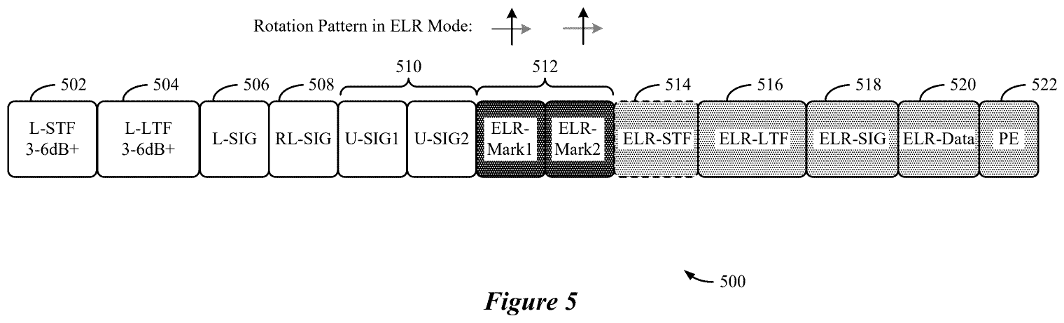

FIG. 5 shows an example ELR PPDU format 500 that supports signal field designs for ELR transmissions. The ELR PPDU format 500 may be an example PPDU format that supports or is otherwise associated with ELR communication. For example, a wireless communication device participating in ELR communication may generate and transmit, or receive and parse, a PPDU in accordance with the ELR PPDU format 500.

In accordance with the ELR PPDU format 500, a PPDU may include an L-STF 502 (which may be power boosted by approximately 3-6 decibels (dB)), an L-LTF 504 (which may be power boosted by approximately 3-6 dB), an L-SIG field 506, an RL-SIG field 508, a U-SIG field 510 (which may include multiple symbols, such as two symbols, such as a “U-SIG1” and a “U-SIG2”), an ELR field 512 (such as an ELR-mark field) including a set of ELR symbols (such as ELR-mark symbols, such as two ELR-mark symbols), an ELR-STF field 514, an ELR-LTF field 516, an ELR-SIG field 518, and an ELR-data field 520. The ELR-STF field 514 may include one or multiple ELR-STF symbols. The ELR-LTF field 516 may include one or multiple ELR-LTF symbols. The set of ELR symbols of the ELR field 512 may be associated with a rotation pattern in an ELR mode. In some implementations, the U-SIG field 510 may include a same or similar set of version independent fields as defined in one or more other U-SIG field formats, such as in a U-SIG field of an EHT PPDU. The ELR-SIG field 518 may immediately follow (such as be located right after or immediately subsequent to) the ELR-LTF field 516, such that the ELR-LTF field 516 may be adjacent to the ELR-SIG field 518 in accordance with the ELR PPDU format 500.

In some examples, the ELR PPDU format 500 may include a PE field 522. The PE field 522 may be part of a payload portion or may be after the payload portion. A transmitting device may include the PE field 522 within a PPDU in accordance with the ELR PPDU format 500. In some aspects, the PE field 522 may be associated with a fixed or static length or size. For example, the PE field 522 may be associated with a fixed PE value (which may be indicated by an ELR-SIG field 518, if included).

In some implementations, the ELR-STF may have same length as UHR DL OFDMA with four RU52 (such as a total length or duration of 4 microseconds (μs) long in accordance with a periodicity of 0.8 us with 5 periods), plus further 3 dB boosting. In some implementations, the ELR-LTF may have a total length or duration of 12.8 us plus guard intervals (GIs) with 3 dB or 6 dB boosting, or may have a total length or duration of 25.6 us plus GIs with 3 dB boosting or without power boosting, or may have a total length or duration of 51.2 us plus GIs with or without power boosting. In some implementations, an ELR PPDU may have a fixed/single mode of LTF+GI, such as one of 2×-LTF+1.6 μs GI, 4×-LTF+0.8 μs GI or 3.2 μs GI, or 4×-LTF+1.6 μs GI. Without counting one or more GIs, 2×-LTF may have a length or duration of 6.4 us and 4×-LTF may have a length or duration of 12.8 μs. Thus, a 12.8 μs ELR-LTF may be one 4×-LTF or two 2×-LTFs. A 25.6 μs ELR-LTF may be two 4×-LTFs or four 2×-LTFs. A 51.2 μs ELR-LTF may be four 4×-LTFs.

In some implementations, a transmitting device may include one or more indications within one or more fields or subfields a PPDU associated with the ELR PPDU format 500 to reduce false alarms (such as to enable the receiving device to accurately ascertain whether the PPDU is an ELR PPDU or a non-ELR PPDU) or enable an “early drop” of the PPDU at one or more unintended receivers of the PPDU. As used herein, a “false alarm” herein may be understood as a scenario in which a receiving device parses a PPDU in accordance with incorrectly determining that the received PPDU is an ELR PPDU, or vice versa. Additionally, or alternatively, the transmitting device may structure, design, organize, or format the ELR-SIG field 518 to provide information in accordance with which a receiving device may parse (such as demodulate and decode) the ELR-data field 520 with low latency, which may provide higher quality wireless communication and greater likelihoods of successful communication, which may in turn support higher data rates and greater network capacity.

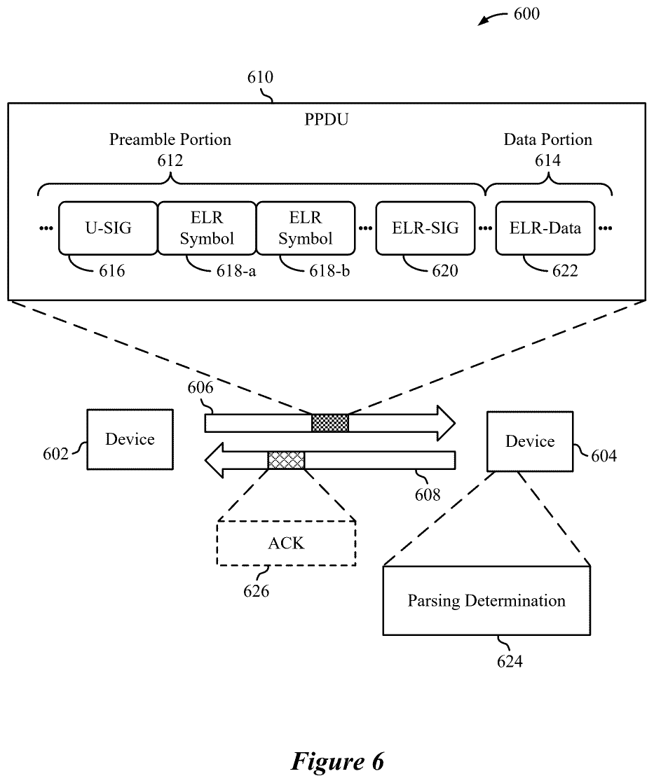

FIG. 6 shows an example signaling diagram 600 that illustrates communication of an ELR PPDU between two wireless communication devices. For example, the signaling diagram 600 illustrates communication between a wireless communication device 602 and a wireless communication device 604 via a communication link 606 and a communication link 608. The wireless communication device 602 may be an example of a STA 104 or an AP 102, such as a STA 104 or an AP 102 as illustrated by and described with reference to FIG. 1. The wireless communication device 604 may be an example of a STA 104 or an AP 102, such as a STA 104 or an AP 102 as illustrated by and described with reference to FIG. 1. Generally, the wireless communication device 602 may be understood or function as a transmitting device and the wireless communication device 604 may be understood or function as a receiving device.

For example, the wireless communication device 602 may transmit, via the communication link 606, a PPDU 610 and the wireless communication device 604 may receive, via the communication link 606, the PPDU 610. In some aspects, the PPDU 610 may be associated with an ELR format, such as the ELR PPDU format 500 as illustrated by and described with reference to FIG. 5. In examples in which the PPDU 610 is associated with the ELR PPDU format 500, a preamble portion 612 of the PPDU 610 may include a U-SIG field 616, an ELR field (such as an ELR-mark field) including an ELR symbol 618-a and an ELR symbol 618-b, and an ELR-SIG field 620, among other fields (as illustrated by and described with reference to FIG. 5). The preamble portion 612 may be understood or referred to herein as an ELR preamble. A data portion 614 of the PPDU 610 may include an ELR-data field 622, among other potential data fields.

The U-SIG field 616 may include a version independent portion and a version dependent portion and, in some aspects, the reserved bits within the version dependent portion of the U-SIG field 616 may be any combination of one or more disregard bits, one or more validate bits (such as a set of multiple validate bits), or one or more information bits. In some implementations, the U-SIG field 616 may include an implicit or an explicit indication that the PPDU 610 is associated with an ELR format. The ELR-SIG field 620 may span or include one or two symbols and, in some aspects, the wireless communication device 602 may transmit the ELR-SIG field 620 using MCS 0 (such as BPSK with a ½ coding rate)+binary convolution code (BCC). The wireless communication device 602 may duplicate the ELR-SIG field 620 across, via, or over four regular RU52. For example, the ELR-SIG field 620 may have a same or similar tone plan and duplication scheme as the ELR-data field 622 (which also may use duplication across, via, or over four regular RU52) and may be BCC encoded with MCS 0.

In some implementations, the wireless communication device 604 may receive and parse at least a portion of the PPDU 610 and, in accordance with parsing the portion of the PPDU 610, may perform a parsing determination 624. In accordance with the parsing determination 624, the wireless communication device 604 may select, determine, calculate, identify, or otherwise ascertain whether to continue parsing the PPDU 610 or to drop (and not parse) a remainder of the PPDU 610. Thus, the parsing determination 624 performed by the wireless communication device 604 may be equivalently referred to as a mode classification, a mode detection, a parsing decision, a parsing selection, a parsing calculation, or a parsing identification, among other examples. In examples in which the wireless communication device 604 drops a remainder of the PPDU 610 in accordance with the parsing determination 624, the wireless communication device 604 may be understood as performing an “early drop” of the PPDU 610, which may save power and processing resources at the wireless communication device 604.

The wireless communication device 604 may drop a remainder of the PPDU 610 in association with selecting, determining, identifying, calculating, or otherwise ascertaining that the wireless communication device 604 is not an intended receiver of the PPDU 610, that the wireless communication device 604 is not associated with a same BSS as an intended receiver of the PPDU 610, or that the wireless communication device 604 is a non-ELR-capable device (and therefore not capable of parsing the PPDU 610, if the PPDU 610 is associated with an ELR format). Alternatively, the wireless communication device 604 may continue parsing (at least a portion of) the PPDU 610 in association with selecting, determining, identifying, calculating, or otherwise ascertaining that the wireless communication device 604 is an intended receiver of the PPDU 610, that the wireless communication device 604 is associated with a same BSS as an intended receiver of the PPDU 610, or that the wireless communication device 604 is an ELR-capable device (and therefore is capable of parsing the PPDU 610, if the PPDU 610 is associated with an ELR format). If the wireless communication device 604 is the intended receiver and successfully parses the PPDU 610, the wireless communication device 604 may transmit, to the wireless communication device 602 via the communication link 608, an acknowledgment (ACK) 626. The ACK 626 may be a block ACK (BA) frame, among other example feedback frames.

The wireless communication device 602 and the wireless communication device 604 may use any one or more of the U-SIG field 616, the ELR symbol 618-a and the ELR symbol 618-b, and the ELR-SIG field 620 to facilitate or enable the parsing determination 624 at the wireless communication device 604. In some implementations, for example, the wireless communication device 602 and the wireless communication device 604 may use one or more subfields or subfield interpretations of the U-SIG field 616 to facilitate or enable the parsing determination 624 at the wireless communication device 604. Additionally, or alternatively, the wireless communication device 602 and the wireless communication device 604 may use one or more subfields or subfield interpretations of the ELR-SIG field 620 to facilitate or enable the parsing determination 624 at the wireless communication device 604.

Further, in some aspects, there may be an absence of additional symbols/cushion between the ELR-SIG field 620 and an ELR-data field 622. In such aspects, the wireless communication device 602 and the wireless communication device 604 may use one or more subfields, subfield interpretations, or formats of the ELR-SIG field 620 to reduce a decoding delay for the ELR-SIG field 620 (such as to provide sufficient time for the wireless communication device 604 to prepare one or more components, such as one or more receivers, to receive the ELR-data field 622). In some implementations, the wireless communication device 602 and the wireless communication device 604 may support a one-symbol design for the ELR-SIG field 620 to carry control information that the wireless communication device 604 may use for demodulation of the ELR-data field 622. In some other implementations, the wireless communication device 602 and the wireless communication device 604 may support a two-symbol design for the ELR-SIG field 620, with the first symbol or relatively earlier subfields of the ELR-SIG field 620 carrying the control information (such as the relatively more useful control information) that the wireless communication device 604 may use for demodulation of the ELR-data field 622. The two symbols may be separately encoded or jointly encoded.

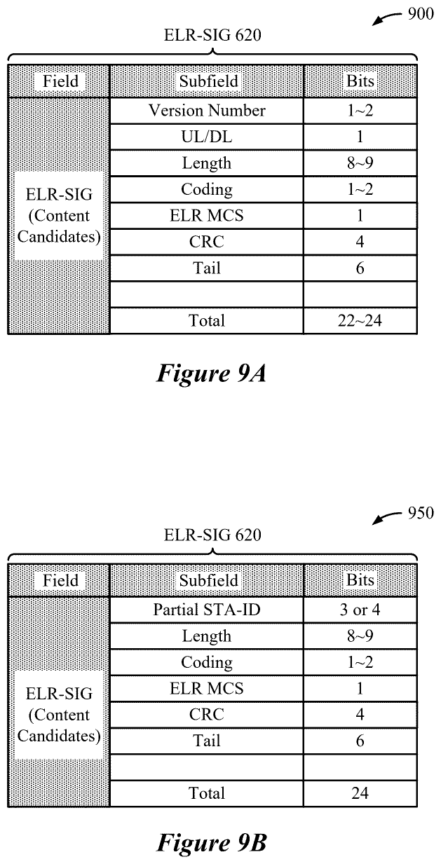

In implementations in which the ELR-SIG field 620 includes or spans one symbol, the ELR-SIG field 620 may include a version number subfield (of 1 or 2 bits), an uplink/downlink indicator subfield (of 1 bit), a length subfield (of 7, 8, or 9 bits), a coding subfield (of 1 or 2 bits), an MCS subfield (of 1 bit), a CRC subfield (of 4 bits), a tail subfield (of 6 bits), or a partial STA-ID/association identifier (AID) subfield (of 3 or 4 bits, among other examples), or any combination thereof. As described herein, a coding subfield may be an LDPC/BCC coding subfield. Further details and examples of one-symbol ELR-SIG fields 620 are illustrated by and described with reference to FIGS. 9A and 9B.

In implementations in which the ELR-SIG field 620 includes or spans two symbols, the wireless communication device 602 and the wireless communication device 604 may format the ELR-SIG field 620 in a manner that provides sufficient time for the wireless communication device 604 to configure a data reception processing (for receiving an ELR-data field 622). In some aspects, the two ELR-SIG symbols may be separately encoded (and jointly decoded). In such aspects, each ELR-SIG symbol may include or carry 14 information bits. Further, in such aspects, the wireless communication device 602 may place an MCS subfield and a coding (LDPC/BCC coding) subfield within a first set of relatively earlier subfields (such as subfields within the first symbol) and may place other subfields, including a CRC subfield and a tail subfield, within a second set of relatively later subfields (such as subfields within the second symbol). In accordance with such aspects, the wireless communication device 604 may prepare the switch in MCS and coding during the second set of subfields (such as during the second symbol), which may provide the wireless communication device 604 with more time to prepare for data demodulation.

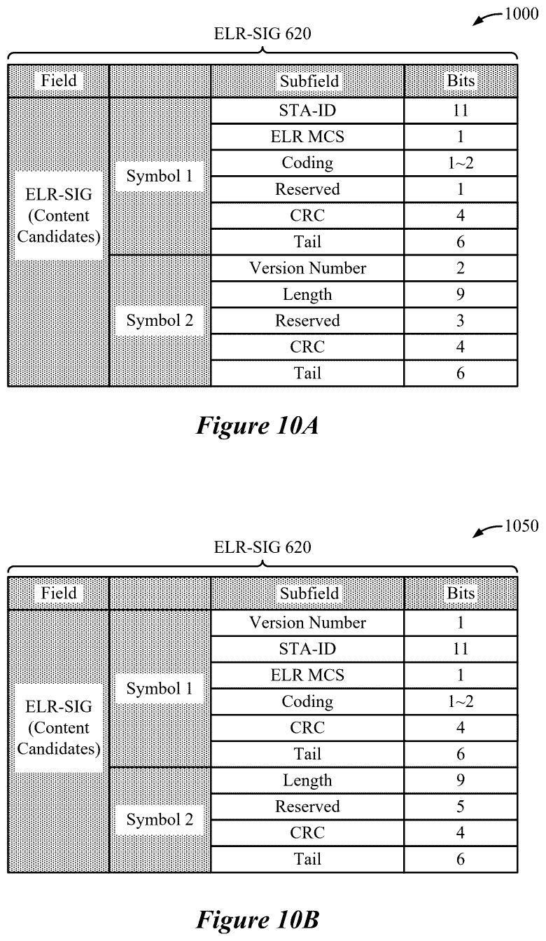

In examples in which the two ELR-SIG symbols are separately encoded, the ELR-SIG field 620 may include a version number subfield (of 1 or 2 bits, sometimes located within the first symbol), a STA-ID subfield (of 11 bits for a full ID or of 3, 4, or 8 bits, among other examples, for a partial ID, sometimes located within the first symbol), a coding subfield (of 1 or 2 bits, sometimes located within the first symbol), an MCS subfield (of 1 bit, sometimes located within the first symbol), a length subfield (of 7, 8, or 9 bits, located in the first symbol or the second symbol), a BSS color subfield (of 6 bits, located in the first symbol or the second symbol), an uplink/downlink indicator subfield (of 1 bit), a CRC subfield (of 4 bits, located in one or both of the first symbol and the second symbol), or a tail subfield (of 6 bits, located in one or both of the first symbol and the second symbol), or any combination thereof. In such examples, the first and second symbols may have separated tail bits and may have separated or joint CRC bits. Additional details relating to such two separately encoded ELR-SIG symbols are illustrated and described herein, including by and with reference to FIGS. 10A-12.

In some other aspects, the two ELR-SIG symbols may be jointly encoded (and jointly decoded). In examples in which the two ELR-SIG symbols are jointly encoded, the ELR-SIG field 620 may include a version number subfield (of 1 or 2 bits), a STA-ID subfield (of 11 bits), a coding (LDPC/BCC coding) subfield (of 1 or 2 bits), an MCS subfield (of 1 bit), a length subfield (of 7, 8, or 9 bits), an LDPC extra symbol segment subfield (of 1 bit), a pre-FEC padding factor subfield (of 2 bits), a BSS color subfield (of 6 bits), a TXOP subfield (of 7 bits), a CRC subfield (of 4 bits), or a tail subfield (of 6 bits), or any combination thereof.

In examples in which the length subfield of the ELR-SIG field 620 includes 7 bits, and if a packet duration is less than a threshold duration (such as less than 128 OFDM symbols), the wireless communication device 602 and the wireless communication device 604 may use one symbol as a resolution/unit of the length indicated by the length subfield. Otherwise, if the packet duration is greater than or equal to the threshold duration (such as greater than or equal to 128 OFDM symbols), the wireless communication device 602 and the wireless communication device 604 may use two symbols as the resolution/unit of the length indicated by the length subfield. In examples in which the length subfield of the ELR-SIG field 620 includes 9 bits, the wireless communication device 602 and the wireless communication device 604 may use one symbol as a resolution/unit of the length indicated by the length subfield.

In examples in which the length subfield of the ELR-SIG field 620 includes 8 bits, for a value “L” of the length subfield in a range of 0-63, the wireless communication device 602 and the wireless communication device 604 may calculate, select, or otherwise determine a (total) quantity of ELR data symbols as in accordance with a first equation. Such a first equation may be, for example, # of ELR data symbols=L+1. Alternatively, for a value “L” of the length subfield in a range of 64-255, the wireless communication device 602 and the wireless communication device 604 may calculate, select, or otherwise determine a (total) quantity of ELR data symbols as in accordance with a second equation. Such a second equation may be, for example, # of ELR data symbols=(L−64)*2+66=2L−62.

Additionally, or alternatively, the ELR-SIG field 620 may include a PE dis-ambiguity subfield (of 1 bit). The PE dis-ambiguity subfield may be conditionally present in accordance with a presence or a size of the length subfield. For example, in examples in which the length subfield indicates the quantity of OFDM symbols without ambiguity, the PE dis-ambiguity subfield may be absent. The PPDU 610 may include a PE in accordance with a decoding delay associated with the PPDU 610. In some aspects, the PE dis-ambiguity subfield may be conditionally present in accordance with whether PE is fixed to a static value. In some examples, the PE may be a fixed or static duration for ELR communication, such as fixed to 4 or 8 μs. For example, the PE may be fixed (such as in accordance with a network specification) to be equal to 8 μs. In such examples, the ELR-SIG field 620 may exclude a PE dis-ambiguity subfield.

Additionally, or alternatively, the ELR-SIG field 620 may include a BSS color subfield (of 6 bits). The ELR-SIG field 620 may conditionally include a BSS color subfield in accordance with whether the ELR-mark (such as the ELR symbol 618-a and the ELR symbol 618-b) indicate a BSS color. For example, if the wireless communication device 602 transmits an ELR-mark sequence via the ELR symbol 618-a and the ELR symbol 618-b indicative of a BSS color (such as a BSS color associated with an intended/addressed receiver or a transmitter of the PPDU 610), the ELR-SIG field 620 may exclude a BSS color subfield. Alternatively, if the wireless communication device 602 uses the ELR symbol 618-a and the ELR symbol 618-b for another purpose (outside of a BSS color indication), the ELR-SIG field 620 may include a BSS color subfield. In some examples, the wireless communication device 602 may transmit an ELR-mark sequence via the ELR symbol 618-a and the ELR symbol 618-b indicative of a BSS color and may additionally include a BSS color subfield within the ELR-SIG field 620 to reinforce (such as with redundancy) the BSS color indication provided by the PPDU 610.

Additionally, or alternatively, the ELR-SIG field 620 may include a TXOP subfield (of 7 bits). In some aspects, the wireless communication device 602 may exclude a TXOP subfield from the ELR-SIG field 620 in accordance with the PPDU 610 being associated with an ELR format. For example, in accordance with the wireless communication device 602 being potentially relatively distant from the wireless communication device 604 (which may be (implicitly) indicated to the wireless communication device 604 in accordance with the wireless communication device 604 being unable to decode the U-SIG field 616 of the PPDU 610), the wireless communication device 604 may not be expected to defer to a TXOP of the wireless communication device 602. In other words, if a receiving device is unable to decode the U-SIG field 616, the receiving device (such as an ELR-capable bystander) may not be expected to honor or respect a TXOP of the transmitting device as potentially indicated by the ELR-SIG field 620). In some other aspects, the ELR-SIG field 620 may include a TXOP subfield and the wireless communication device 604 may honor or respect (such as not transmit within) the TXOP indicated by the TXOP subfield.

In some implementations, the ELR-SIG field 620 may include one or more subfields associated with rate matching, such as rate matching associated with the data portion 614 or the ELR-data field 622. In some examples, such one or more subfields may include an LDPC extra symbol segment subfield (of 1 bit). The LDPC extra symbol segment subfield may be conditionally present, such as in accordance with a type of the LDPC used for the data portion 614 or the ELR-data field 622 or in accordance with whether an extra symbol segment is fixed to a static value. For example, the LDPC extra symbol segment subfield may be absent if the extra symbol segment is fixed (in accordance with a network specification or one or more network/operator rules) to be equal to, for example, 0, 1, or 4.

Additionally, or alternatively, such one or more subfields may include a (common) pre-FEC padding factor subfield (of 2 bits). The pre-FEC padding factor subfield may indicate a value of “0,” “1,” “2,” or “3,” which may correspond to or indicate a pre-FEC padding factor (which may be denoted as a) of “4,” “1,” “2,” or “3,” respectively. In some aspects, the pre-FEC padding factor subfield may be conditionally present in accordance with a coding type or a simplified LDPC rate matching or in accordance with whether the pre-FEC padding factor is fixed to a static value. For example, if the pre-FEC padding factor is fixed such that a=4, the pre-FEC padding factor subfield may be absent. The wireless communication device 602 may set a=4 in examples in which an LDPC extra symbol segment is equal to 0, 1, or 4.

In some implementations, the wireless communication device 602 may employ a rate matching scheme that is associated with (such as specific or dedicated to) ELR communication. The rate matching scheme may be BCC rate matching or LDPC rate matching. In BCC rate matching, the wireless communication device 602 may set both a pre-FEC padding boundary and a PHY coded bits boundary to be at the end of a last symbol in the ELR-data field 622. In LDPC rate matching, the wireless communication device 602 may set the PHY coded bits boundary at the end of the last symbol of the ELR-data field 622, with potentially no post-FEC padding. In some aspects, in LDPC rate matching, the wireless communication device 602 may include additional pre-FEC padding to make the pre-FEC padding boundary reach a fixed segment, depending on one or more of various schemes or options. Further, in some aspects, there may be a fixed amount of LDPC extra symbol segments (such as, for example, 0, 1, or 4) depending on one or more of various schemes or options.

In some aspects, the wireless communication device 602 may perform or apply a two-step padding process to the PPDU 610. The wireless communication device 602 may apply a pre-FEC padding process including both pre-FEC MAC and pre-FEC PHY padding before conducting FEC coding, and may apply a post-FEC PHY padding process on the FEC encoded bits. Four pre-FEC padding boundaries may partition the last OFDM symbol of the PPDU 610 into four symbol segments. The pre-FEC padding may pad toward one of the four possible boundaries. The four pre-FEC padding boundaries may be represented by a pre-FEC padding factor parameter a.

In a first step of LDPC rate matching, the wireless communication device 602 (or the wireless communication device 604, or both) may determine an LDPC pre-FEC padding boundary. For the PPDU 610 transmission, the wireless communication device 602 (or the wireless communication device 604, or both) may initially compute a quantity of data bits in a last OFDM symbol for user u in accordance with:

$${N}_{Excess , u} = ( 8 \cdot {APEP}_{{LENGTH}_{u}} + {N}_{tail , u} + {N}_{service} ) mod {N}_{DBPS , u}$$

In some aspects, APEP_LENGTHᵤ may be the TXVECTOR parameter APEP_LENGTH for the u-th user, N_{tail,u} may be the quantity of tails bits per encoder for user u, and N_{tail,u}=6 for binary convolutional coding (BCC) and N_{tail,u}=0 for LDPC, N_{service}=16 may be the quantity of bits in the SERVICE field, and N_{DBPS,u}=floor (N_{CBPS,u}·Rᵤ) may be the quantity of data bits per OFDM symbol for the u-th user, where Rᵤ may be the nominal coding rate for the u-th user; N_{CBPS,u}=N_{SD,u}·N_{ss,u}·N_{BPSCS,u} may be the quantity of coded bits per OFDM symbol for user u, in which N_{SD,u} may be the N_{SD} (effective number of data tones carrying unique data in one OFDM symbol) value corresponding to the occupied RU or multiple RU (MRU) size of the u-th user, N_{ss,u} may be the number of spatial streams for the u-th user, and N_{BPSCS,u} may be the quantity of coded bits per OFDM symbol per spatial stream for user u.

In accordance with N_{Excess,u}, the wireless communication device 602 (or the wireless communication device 604, or both) may compute the initial quantity of symbol segments in the initial last OFDM symbol, such as the initial pre-FEC padding factor value a_{init,u} and the initial quantity of OFDM symbols, N_{SYM,init,u}, for user u using the following equations.

$${a}_{init , u} = \{ \begin{matrix}4 , & if {N}_{Excess , u} = 0 \\ min ( ⌈ \frac{{N}_{Excess , u}}{{N}_{DBPS , short , u}} ⌉ , 4 ) , & otherwise\end{matrix}$$

$${N}_{SYM , init , u} = ⌈ \frac{8 \cdot {APEP}_{{LENGTH}_{u}} + {N}_{tail , u} + {N}_{service}}{{N}_{DBPS , u}} ⌉$$

In some aspects, N_{DBPS,short,u}=N_{CBPS,short,u}·Rᵤ. Further, N_{CBPS,short,u}=N_{SD,short,u}·N_{ss,u}·N_{BPSCS,u}, in which N_{SD,short,u} may be the N_{SD,short} (effective quantity of data tones carrying unique data in each symbol segment of the first three symbol segments) value corresponding to the occupied RU or MRU size of the u-th user.

Among the users, the wireless communication device 602 (or the wireless communication device 604, or both) may derive the set of the user indices S, with the longest encoded packet duration as in the following equation, and may select one value from the set as uₘₐₓ.

$$S = arg {max}_{0 \leq u \leq {N}_{user , total} - 1} ( {N}_{SYM , init , u} - 1 + \frac{{a}_{init , u}}{4} )$$

In the context of the above equation:

$$\begin{matrix}arg max f ( x ) : \text{=} \{ x ∈ [ 0 , {N}_{user , total} - 1 ] \text{:} f ( y ) \leq f ( x ) for all y \\ ∈ [ 0 , {N}_{user , total} - 1 ] \}\end{matrix}$$

In some aspects, the wireless communication device 602 (or the wireless communication device 604, or both) may derive the common aᵢₙᵢₜ and N_{SYM,init} values among all the users using the following equations.

$${N}_{SYM , init} = {N}_{SYM , init , {u}_{max}}$$

$${a}_{init} = {a}_{init , {u}_{max}}$$

The wireless communication device 602 (or the wireless communication device 604, or both) may calculate each user's initial quantity of data bits N_{DBPS,last,init,u} and initial quantity of coded bits N_{CBPS,last,init,u} in its last OFDM symbol in accordance with the following equations, respectively.

$${N}_{DBPS , last , init , u} = \{ \begin{matrix}{a}_{init} \cdot {N}_{DBPS , short , u} & if {a}_{init} < 4 \\ {N}_{DBPS , u} & if {a}_{init} = 4\end{matrix}$$

$${N}_{CBPS , last , init , u} = \{ \begin{matrix}{a}_{init} \cdot {N}_{CBPS , short , u} & if {a}_{init} < 4 \\ {N}_{CBPS , u} & if {a}_{init} = 4\end{matrix}$$

For each user with LDPC encoding, the wireless communication device 602 (or the wireless communication device 604, or both) may compute the parameters N_{pld,u} and N_{avbits,u} using the following equations, respectively.

$${N}_{pld , u} = ( {N}_{SYM , init} - 1 ) {N}_{DBPS , u} + {N}_{DBPS , last , init , u}$$

$${N}_{avbits , u} = ( {N}_{SYM , init} - 1 ) {N}_{CBPS , u} + {N}_{CBPS , last , init , u}$$

N_{pld,u} may be the PHY payload size, such as the quantity of data bits including pre-FEC padding bits, that fits in the PHY payload boundary (such as the pre-FEC padding boundary), which may be the end of the symbol segment aᵢₙᵢₜ in the OFDM symbol N_{SYM,init}. N_{avbits,u} may be the quantity of PHY coded bits that fits in the current PHY coded bits boundary, which may be the end of the symbol segment aᵢₙᵢₜ in the OFDM symbol N_{SYM,init}. Accordingly, the effective code rate associated with these two values may be calculated in accordance with:

$${eCR}_{u} = \frac{{N}_{pld , u}}{{N}_{avbits , u}} = \frac{( {N}_{SYM , init} - 1 ) {N}_{DBPS , u} + {N}_{DBPS , last , init , u}}{( {N}_{SYM , init} - 1 ) {N}_{CBPS , u} + {N}_{CBPS , last , init , u}} = {R}_{u}$$

Such an effective code rate may be the nominal code rate Ry of user u. In accordance with adjusting the PHY coded bits boundary by adding one or more OFDM symbols or fractions of symbol (such as one or more symbol segments) to accommodate more PHY coded bits, the wireless communication device 602 (or the wireless communication device 604, or both) may lower the effective code rate and reduce a puncturing ratio.

In a second step of LDPC rate matching, the wireless communication device 602 (or the wireless communication device 604, or both) may determine an LDPC codeword size and a quantity of codewords. In some aspects, the wireless communication device 602 (or the wireless communication device 604, or both) may compute an integer quantity of LDPC codewords to be transmitted for user u, N_{CW,u}, and the length of the codewords to be used for user u, L_{LDPC,u}, in accordance with Table 1, shown below.

TABLE 1
PPDU Encoding Parameters

| | Number of | |
|---|---|---|
| | LDPC | |
| Range of N_{avbits} | Codewords | |
| (bits) | (N_{CW}) | LDPC Codeword Length L_{LDPC} (bits) |
| N_{avbits} ≤ 648 | 1 | 1296, if N_{avbits} ≥ N_{pld} + 912 × (1 − |
| | | R); 648 otherwise. |
| 648 < N_{avbits} ≤ | 1 | 1944, if N_{avbits} ≥ N_{pld} + 1464 × (1 − |
| 1296 | | R); 1296 otherwise. |
| 1296 < N_{avbits} ≤ | 1 | 1944 |
| 1944 | | |
| 1944 < N_{avbits} ≤ | 2 | 1944, if N_{avbits} ≥ N_{pld} + 2916 × (1 − |
| 2592 | | R); 1296 otherwise. |
| 2592 < N_{avbits} | $⌈ \frac{{N}_{pld}}{1944 \cdot R} ⌉$ | 1944 |

In a third step of LDPC rate matching, the wireless communication device 602 (or the wireless communication device 604, or both) may compute a quantity of shortening bits for user u, N_{shrt,u}, to be padded to the N_{pld,u} data bits before encoding, in accordance with the following equation.

$${N}_{shrt , u} = max ( 0 , {N}_{CW , u} \cdot {L}_{LDPC , u} \cdot {R}_{u} - {N}_{pld , u} )$$

If N_{shrt,u}=0, shortening may not be performed. If N_{shrt,u}>0, shortening bits may be equally distributed over all N_{CW,u} codewords with the first rem (N_{shrt,u}, N_{CW,u}) codewords being shortened one bit more than the remaining codewords. Shortening bits may be appended after data bits. The shortening bits may be discarded after encoding.

In a fourth step of LDPC rate matching, the wireless communication device 602 (or the wireless communication device 604, or both) may compute a quantity of bits to be punctured for user u, N_{punc,u}, from the codewords after encoding, as follows.

$${N}_{punc , u} = max ( 0 , {N}_{CW , u} \cdot {L}_{LDPC , u} - {N}_{avbits , u} - {N}_{shrt , u} )$$

If N_{punc,u}=0, puncturing may not be performed. If N_{punc,u}>0, puncturing bits may be equally distributed over all N_{CW,u} codewords with the first rem (N_{punc,u}, N_{CW,u}) codewords being punctured one bit more than the remaining codewords. In some aspects, parity bits may be punctured while systematic bits may not be punctured.

If there is at least one user with LDPC encoding for which the following condition in LDPC encoding process is met:

$$( {N}_{punc , u} > 0.1 \cdot {N}_{CW , u} \cdot {L}_{LDPC , u} \cdot ( 1 - {R}_{u} ) )$$

$$AND$$

$$( {N}_{shrt} < 1.2 \cdot {N}_{punc , u} \cdot {R}_{u} / ( 1 - {R}_{u} ) )$$

is true; OR if

$${N}_{punc , u} > 0.3 \cdot {N}_{CW , u} \cdot {L}_{LDPC , u} \cdot ( 1 - {R}_{u} )$$

is true, for any user u, a set of (such as all) users with LDPC encoding may increment N_{avbits,u} by an extra symbol segment and recompute N_{punc,u} based on the new N_{avbits,u} value.

$${N}_{avbits , u} = \{ \begin{matrix}{N}_{avbits , u} + {N}_{CBPS , u} - 3 {N}_{CBPS , short , u} , & if {a}_{init} = 3 \\ {N}_{avbits , u} + {N}_{CBPS , short , u} , & otherwise\end{matrix}$$

The wireless communication device 602 (or the wireless communication device 604, or both) may update the common pre-FEC padding factor a and N_{SYM} values for a set of (such as all) users using the following:

$$\{ \begin{matrix}{N}_{SYM} = {N}_{SYM , init} + 1 and a = 1 , & if {a}_{init} = 4 \\ {N}_{SYM} = {N}_{SYM , init} and a = {a}_{init} + 1 , & otherwise\end{matrix}$$

In some aspects, the last OFDM symbol may be the next OFDM symbol of the initial last OFDM symbol, if aᵢₙᵢₜ=4. Because N_{avbits,u} may be updated with a larger value, more PHY coded bits may fit in the adjusted PHY coded bits boundary, which may be the end of the symbol segment a in the OFDM symbol N_{SYM}.

Alternatively, if the above condition in LDPC encoding process is not met by any of the users with LDPC encoding, or if a set of (such as all) the users scheduled in the PPDU 610 are BCC encoded, no extra symbol segment may be added. The wireless communication device 602 may update the common pre-FEC padding factor a and N_{SYM} values for a set of (such as all) users using the following:

$${N}_{SYM} = {N}_{SYM , init} and a = {a}_{init}$$

The wireless communication device 602 (or the wireless communication device 604, or both) may compute the quantity of coded bits to be repeated for user u, N_{rep,u}, as follows:

$${N}_{rep , u} = max ( 0 , {N}_{avbits , u} - {N}_{CW , u} \cdot {L}_{LDPC , u} \cdot ( 1 - {R}_{u} ) - {N}_{pld , u} )$$

If N_{rep,u}=0, repetition may not be performed. If N_{rep,u}>0, the quantity of coded bits to be repeated may be equally distributed over all N_{CW,u} codewords with one more bit repeated for the first rem (N_{rep,u}, N_{CW,u}) codewords than the remaining codewords. The coded bits to be repeated for any codeword may be copied from that codeword itself, starting from the beginning of that LDPC codeword (beginning of data bits). In some aspects, if puncturing occurs, the coded bits are not repeated, and vice versa.

In a fifth step of LDPC rate matching, the wireless communication device 602 (or the wireless communication device 604, or both) may finalize the LDPC/BCC pre-FEC padding and post-FEC padding. For the users with LDPC encoding, the wireless communication device 602 may update N_{DBPS} of the last OFDM symbol as:

$${N}_{DBPS , last , u} = {N}_{DBPS , last , init , u}$$

For the users with BCC encoding, the wireless communication device 602 (or the wireless communication device 604, or both) may update N_{DBPS} of the last OFDM symbol as:

$${N}_{DBPS , last , u} = \{ \begin{matrix}a \cdot {N}_{DBPS , short , u} , & if a < 4 \\ {N}_{DBPS , u} , & if a = 4\end{matrix}$$

For each user with either LDPC or BCC encoding, the wireless communication device 602 (or the wireless communication device 604, or both) may update N_{CBPS} of the last OFDM symbol as:

$${N}_{CBPS , last , u} = \{ \begin{matrix}a \cdot {N}_{CBPS , short , u} , & if a < 4 \\ {N}_{CBPS , u} , & if a = 4\end{matrix}$$

For each user with LDPC encoding, the quantity of pre-FEC padding bits for the u-th user may be computed as in the following equation.

$${N}_{PAD , Pre - FEC , u} = ( {N}_{SYM , init} - 1 ) {N}_{DBPS , u} + {N}_{DBPS , last , init , u} - 8 \cdot {APEP}_{{LENGTH}_{u}} - {N}_{service}$$

In some aspects, the PHY payload boundary (such as the pre-FEC padding boundary) for users using LDPC encoding may still be the end of the symbol segment aᵢₙᵢₜ in the OFDM symbol N_{SYM,init}, determined by N_{SYM,init} and aᵢₙᵢₜ.

For the users with BCC encoding, the quantity of pre-FEC padding bits for the u-th user is shown in the following equation.

$${N}_{PAD , Pre - FEC , u} = ( {N}_{SYM - 1} ) {N}_{DBPS , u} + {N}_{DBPS , last , u} - 8 \cdot {APEP}_{{LENGTH}_{u}} - {N}_{tail , u} - {N}_{service}$$

In some aspects, for users using BCC encoding, both the PHY payload boundary (such as the pre-FEC padding boundary) and the PHY coded bits boundary may be the same as the end of the symbol segment a in the OFDM symbol N_{SYM}, determined by N_{SYM} and a.

For each user with either LDPC or BCC encoding, the quantity of post-FEC padding bits in the last symbol may be computed as in the following equation.

$${N}_{PAD , Post - FEC , u} = {N}_{CBPS , u} - {N}_{CBPS , last , u}$$

In some aspects, the post-FEC padding may fill the data tones not occupied by PHY coded bits in the last OFDM symbol, such as the remaining symbol segments in the last OFDM symbol. Among the pre-FEC padding bits, the MAC entity or layer may deliver a PSDU that fills the available octets in the ELR-data field 622 of the PPDU 610, toward the (expected) initial pre-FEC padding boundary represented by aᵢₙᵢₜ for users encoded by LDPC, and toward the (expected) pre-FEC padding boundary represented by a for users encoded by BCC, in the last OFDM symbol of the Data field. The PHY entity or layer may determine the quantity of padding bits to add and appends them to the PSDU. The quantity of pre-FEC padding bits added by the PHY entity or layer may be in a range of 0-7.

In the ELR mode, there may be only one user (such as the wireless communication device 604). In such examples, the subscript of u may be omitted. The nominal codeword size L_{ldpc} may be from the set of {648, 1296, 1944}, and the size 3888 may not be used. The nominal code rate may be

$$R = \frac{1}{2} .$$

The RU size in rate matching calculation may be RU52 with 48 data tones and 4 pilot tones, such that N_{SD}=48. Further, there may be a single spatial stream, such that Nₛₛ=1. The rate matching scheme may depend on the coding scheme (BCC or LDPC). In some aspects, both the pre-FEC padding boundary and PHY coded bits boundary may be at the end of the last symbol in the ELR-data field 622. There may be no post-FEC padding, such that N_{PAD,Post-FEC}=0.

In some aspects, the wireless communication device 602 (or the wireless communication device 604, or both) may set N_{SYM} and a in accordance with the following equation (which may be examples of fixed or static values):

$${N}_{SYM} = {N}_{SYM , init} and a = 4$$

In some scenarios, additional pre-FED padding may be used to satisfy a=4. The quantity of data bits in the last OFDM symbol, number of coded bits in the last OFDM symbol, and the total number of pre-FEC padding bits may be calculated using one or more formulas disclosed herein, given N_{SYM}=N_{SYM,init} and a=4.

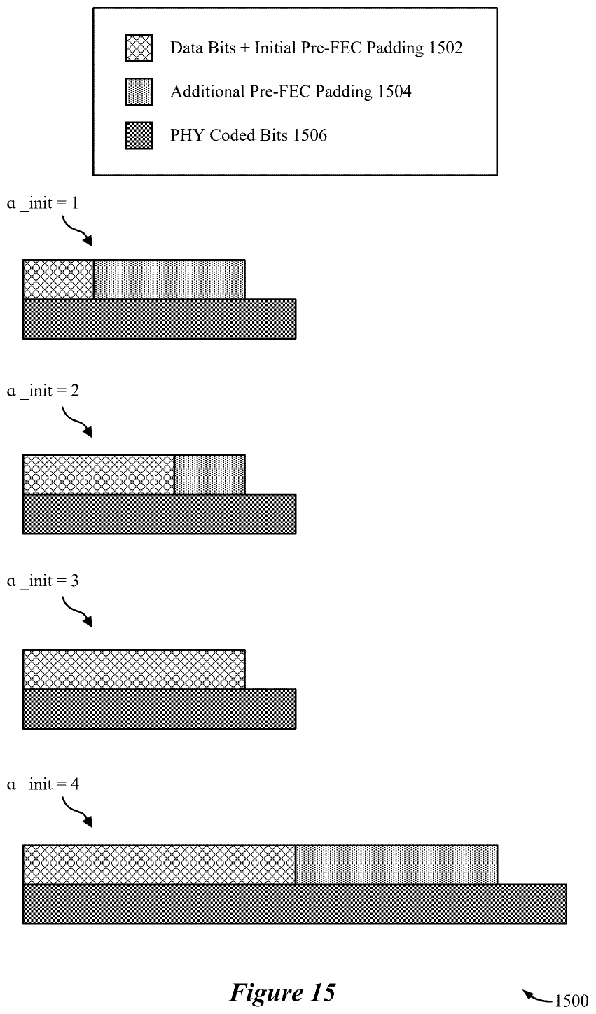

In LDPC rate matching, the PHY coded bits boundary may be at the end of the last symbol in the ELR-data field 622. There may be no post-FEC padding, such that N_{PAD,Post-FEC}=0. There may be additional pre-FEC padding in ELR systems/modes as compared to some other systems, to make the pre-FEC padding boundary reach a fixed segment, depending on the option. There may be a fixed amount of LDPC extra symbol segments (such as 0, 1, or 4), depending on one or more of various schemes or options. Additional details relating to such schemes or options are illustrated and described herein, including by and with reference to FIGS. 15-19.

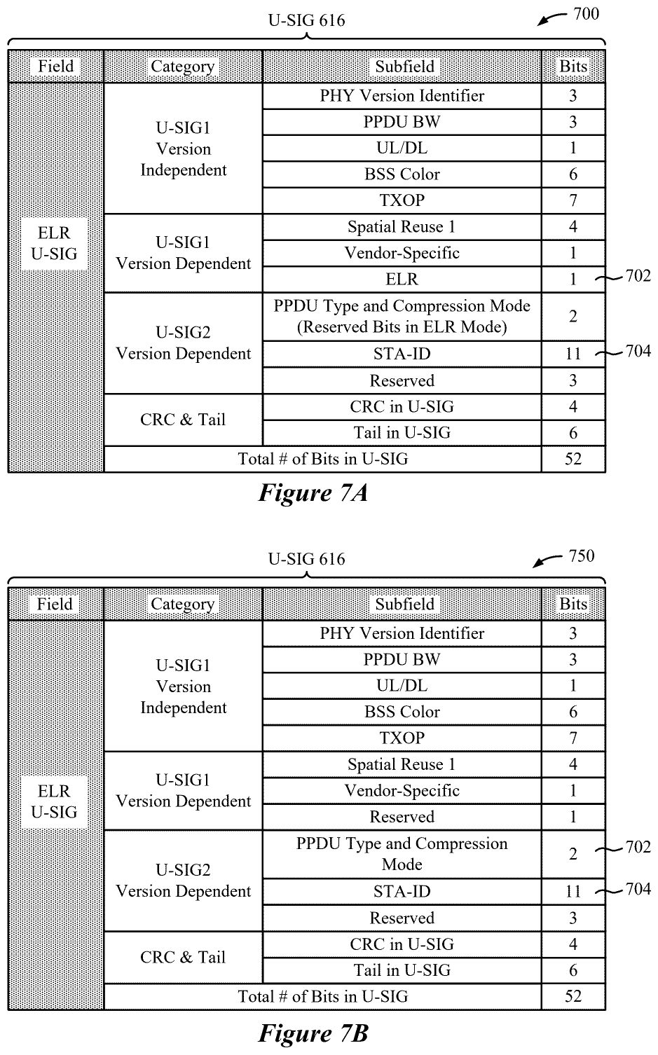

FIGS. 7A and 7B shows example ELR U-SIG field designs 700 and 750, respectively, that support signal field designs for ELR transmissions by including or conveying a first indication that a PPDU is associated with an ELR format and a second indication of a STA-ID of an addressed receiver of the PPDU. In some implementations, the wireless communication device 602 and the wireless communication device 604 may use the ELR U-SIG field design 700 or the ELR U-SIG field design 750 for the U-SIG field 616 to enable or facilitate a selective parsing of the remainder of the PPDU 610 at the wireless communication device 604. For example, the wireless communication device 602 may transmit, via the U-SIG field 616, a first indication 702 of whether the PPDU 610 is associated with an ELR format and a second indication 704 of a STA-ID associated with the PPDU 610 and the wireless communication device 604 may use at least some of such U-SIG content to defer or drop power from the PPDU 610 (such as an ELR packet), which may increase device or network power savings/efficiency, which may in turn increase a device battery life and provide a greater user experience.

In some aspects, the wireless communication device 604 may use the first indication 702 to receive information indicative of whether the PPDU 610 is associated with an ELR format and may compare such received information with a capability associated with the wireless communication device 604 (if the wireless communication device 604 receives the PPDU 610 above a PD threshold and can detect the U-SIG field 616). For example, if the wireless communication device 604 is EHT- or UHR-capable device but a non-ELR-capable device, the wireless communication device 604 may stop parsing the PPDU 610 after the U-SIG field 616 in examples in which the first indication 702 informs the wireless communication device 604 that the PPDU 610 is associated with an ELR format. Generally, the wireless communication device 604 may use at least a PHY version identifier subfield, an uplink/downlink indicator subfield (or bit), a BSS color subfield, and a TXOP subfield to select, identify, determine, or otherwise ascertain whether to continue parsing the PPDU 610.

Additionally, or alternatively, if the wireless communication device 604 is an ELR-capable device, the wireless communication device 604 may continue parsing at least another one or more subfields of the U-SIG field 616 (if not an entirety of a remaining portion of the PPDU 610) in examples in which the first indication 702 informs the wireless communication device 604 that the PPDU 610 is associated with an ELR format. In such examples, the wireless communication device 604 may additionally use the second indication 704 to select, identify, determine, or otherwise ascertain whether the wireless communication device 604 is the intended (such as addressed) receiver of the PPDU 610. In other words, the wireless communication device 604 (as an ELR-capable device) may use at least a PHY version identifier subfield, an uplink/downlink indicator subfield (or bit), a BSS color subfield, a TXOP subfield, and the second indication 704 to select, identify, determine, or otherwise ascertain whether to continue parsing the PPDU 610.

In some implementations, and as illustrated in the example of the ELR U-SIG field design 700, an ELR subfield of the U-SIG field 616 may include the first indication 702. In such implementations, the wireless communication device 602 and the wireless communication device 604 may use a same PHY version identifier number for UHR and ELR and a separate field (such as the ELR subfield) to differentiate between UHR and ELR. For example, a PHY version identifier subfield that includes a codepoint indicative of a first value (such as a “1” value) may indicate that the PPDU 610 is associated with a UHR format or an ELR format (and may not differentiate between the two formats).

In accordance with the example of the ELR U-SIG field design 700, the U-SIG field 616 may include the ELR subfield within a version dependent portion of the U-SIG field 616. In such examples, the ELR subfield may be selectively or conditionally present in accordance with a value of, for example, the PHY version identifier subfield. For example, if the PHY version identifier subfield indicates that the PPDU 610 is associated with a UHR format or an ELR format, the wireless communication device 602 may include the ELR subfield within the version dependent portion of the U-SIG field 616 to provide the first indication 702 to the wireless communication device 604. In examples in which an ELR indication bit is used to provide or carry the first indication 702, the ELR indication subfield (1 bit), a STA-ID subfield (11 bits), a PPDU type and compression mode subfield (2 bits, which may be reserved bits in an ELR mode or in examples in which the PPDU 610 is associated with an ELR format), a spatial reuse subfield (4 bits), a vendor-specific subfield (X bits), and a quantity of reserved bits (4-X bits) may occupy 22 bits of the version dependent subfield (such as portion) in the U-SIG field 616.

In some other implementations, and as illustrated in the example of the ELR U-SIG field design 750, a PPDU type and compression mode subfield may include the first indication 702. In such implementations, the first indication 702 (the ELR indication) is one value or codepoint from the PPDU type and compression mode subfield. For example, the PPDU type and compression mode subfield may include two bits and, accordingly, may convey four different values/codepoints. In some implementations, a value of “0,” “1,” or “2” can indicate a PPDU mode, depending on a value of the uplink/downlink indicator subfield, and a value of “3” may correspond to the first indication 702. In other words, the PPDU type and compression mode subfield indicating a value of “3” may correspond to or provide the first indication 702. The PPDU type and compression mode subfield may indicate such a value of “3” via a codepoint of “11.” In examples in which the PPDU type and compression mode subfield is used to provide or carry the first indication 702, the PPDU type and compression mode subfield (2 bits, including ELR indicated as a state), a STA-ID subfield (11 bits), a spatial reuse subfield (4 bits), a vendor-specific subfield (X bits), and a quantity of reserved bits (5-X bits) may occupy 22 bits in a version dependent portion of the U-SIG field 616.

In accordance with the ELR U-SIG field design 700 and the ELR U-SIG field design 750, a STA-ID subfield (which may be referred to herein as a “STA-ID subfield”) of the U-SIG field 616 may include, carry, or provide the second indication 704. The U-SIG field 616 may include the STA-ID subfield within a version dependent portion of the U-SIG field 616. The STA-ID subfield may occupy 11 bits and, in some implementations, the U-SIG field 616 may provide room (such as a sufficient quantity of available bits) for the STA-ID subfield in accordance with excluding one or more subfields that may be included in other PPDU formats (such as in EHT or UHR PPDU formats). For example, the U-SIG field 616 may exclude one or more a puncture channel information subfield, an MCS subfield (such as an EHT-MCS subfield), or a number of symbols subfield (such as a number of EHT-SIG symbols).

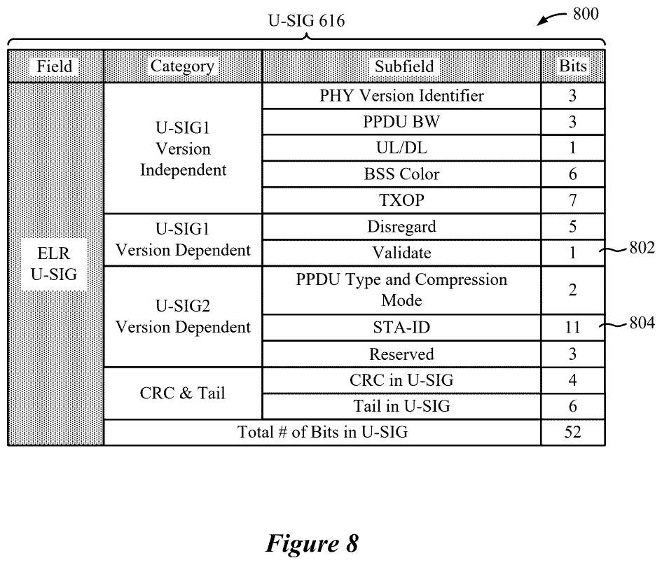

FIG. 8 shows an example ELR U-SIG field design 800 that supports signal field designs for ELR transmissions by including or conveying a first indication that a PPDU is associated with an ELR format and a second indication of a STA-ID of an addressed receiver of the PPDU. In some implementations, the wireless communication device 602 and the wireless communication device 604 may use the ELR U-SIG field design 800 for the U-SIG field 616 to enable or facilitate a selective parsing of the remainder of the PPDU 610 at the wireless communication device 604. For example, the wireless communication device 602 may transmit, via the U-SIG field 616, a first indication 802 of whether the PPDU 610 is associated with an ELR format and a second indication 804 of a STA-ID associated with the PPDU 610 and the wireless communication device 604 may use at least some of such U-SIG content to defer or drop power from the PPDU 610 (such as an ELR packet), which may increase device or network power savings/efficiency, which may in turn increase a device battery life and provide a greater user experience.

The first indication 802 and the second indication 804 may be examples of the first indication 702 and the second indication 704 as illustrated by and described with reference to FIG. 7A or 7B. For example, the wireless communication device 604 may use the first indication 802 to receive information indicative of whether the PPDU 610 is associated with an ELR format and may compare such received information with a capability associated with the wireless communication device 604 (if the wireless communication device 604 receives the PPDU 610 above a PD threshold and can detect the U-SIG field 616). In such examples, if the wireless communication device 604 is EHT- or UHR-capable device but a non-ELR-capable device, the wireless communication device 604 may stop parsing the PPDU 610 after the U-SIG field 616 in examples in which the first indication 802 informs the wireless communication device 604 that the PPDU 610 is associated with an ELR format. The wireless communication device 604 may additionally use the second indication 804 to select, identify, determine, or otherwise ascertain whether the wireless communication device 604 is the intended (such as addressed) receiver of the PPDU 610.

In some implementations, and as illustrated in the example of the ELR U-SIG field design 800, a validate bit of the U-SIG field 616 may include the first indication 802. In such implementations, the wireless communication device 602 and the wireless communication device 604 may use a value of the validate bit to carry or provide the first indication 802. For example, the wireless communication device 602 may set a value of the validate bit to “0” to provide the first indication 802. Further, in such implementations, the wireless communication device 602 and the wireless communication device 604 may use a same PHY version identifier number for UHR and ELR and a separate field (such as the ELR subfield) to differentiate between UHR and ELR. For example, a PHY version identifier subfield that includes a codepoint indicative of a first value (such as a “1” value) may indicate that the PPDU 610 is associated with a UHR format or an ELR format (and may not differentiate between the two formats).

Additionally, or alternatively, the wireless communication device 602 may use one or more disregard bits and the validate bit to carry or provide the first indication 802. For example, the wireless communication device 602 may set the one or more disregard bits (such as a set of five disregard bits, such as a complete set of the disregard bits within the U-SIG field 616) and the validate bit to a “0” value to provide the first indication 802. In other words, setting the disregard bits and the validate bit to “0” values may correspond to or otherwise be used as the first indication 802. In some systems, the wireless communication device 602 may otherwise set the disregard bits and the validate bit to “1” values by default.

In accordance with the ELR U-SIG field design 800, a STA-ID subfield of the U-SIG field 616 may include, carry, or provide the second indication 804. The U-SIG field 616 may include the STA-ID subfield within a version dependent portion of the U-SIG field 616. The STA-ID subfield may occupy 11 bits and, in some implementations, the U-SIG field 616 may provide room (such as a sufficient quantity of available bits) for the STA-ID subfield in accordance with excluding one or more subfields that may be included in other PPDU formats (such as in EHT or UHR PPDU formats). For example, the U-SIG field 616 may exclude one or more a puncture channel information subfield, an MCS subfield (such as an EHT-MCS subfield), a number of symbols subfield (such as a number of EHT-SIG symbols), or a spatial reuse subfield.

FIGS. 9A and 9B show example one-symbol ELR-SIG field designs 900 and 950, respectively, that support signal field designs for ELR transmissions. In some implementations, the wireless communication device 602 and the wireless communication device 604 may leverage the ELR-SIG field design 900 or the ELR-SIG field design 950 to accommodate an early drop at an unintended receiving wireless communication device. Additionally, or alternatively, the wireless communication device 602 and the wireless communication device 604 may leverage the ELR-SIG field design 900 or the ELR-SIG field design 950 to provide an intended receiving wireless communication device with information that the intended receiving wireless communication device may use to parse or decode an ELR-data field 622, which may increase a likelihood of successful communication of the PPDU 610, which may in turn increase data rates and network capacity.

The wireless communication device 602 may format the ELR-SIG field 620 of the PPDU 610 in accordance with the ELR-SIG field design 900 or the ELR-SIG field design 950, with the ELR-SIG field design 900 and the ELR-SIG field design 950 corresponding to one symbol ELR-SIG designs. In other words, in accordance with the ELR-SIG field design 900 or the ELR-SIG field design 950, the ELR-SIG field 620 of the PPDU 610 may span or include one symbol.

In accordance with the ELR-SIG field design 900, the ELR-SIG field 620 may include a version number subfield of 1 or 2 bits, an uplink/downlink indicator subfield of 1 bit, a length subfield of 8 or 9 bits, a coding subfield (such as an LDPC/BCC subfield) of 1 or 2 bits, an MCS subfield of 1 bit, a CRC subfield of 4 bits, and a tail subfield of 6 bits. The ELR-SIG field 620 may sometimes exclude the version number subfield. The length subfield may indicate a length of the data portion 614 or of the ELR-data field 622 in units of symbols, such as OFDM symbols. In some implementations, the ELR-SIG field 620 may exclude a STA-ID (as for example, a MAC address of the intended/addressed receiver of the PPDU 610 may follow after, such as immediately after, the ELR-SIG field 620). Further, in some implementations, the ELR symbol 618-a and the ELR symbol 618-b may carry or indicate a BSS color associated with the PPDU 610 (such as via an ELR-mark sequence). The ELR-SIG field 620 may exclude a beamforming bit as, for example, the wireless communication device 602 and the wireless communication device 604 may refrain from performing beamforming for ELR transmissions (due to, for example, a low SNR condition associated with at least some ELR transmissions). The length subfield may be 8 or 9 bits in accordance with a length subfield in an L-SIG field being 12 bits.

In accordance with the ELR-SIG field design 950, the ELR-SIG field 620 may include a partial STA-ID subfield of 3 or 4 bits, a length subfield of 8 or 9 bits, a coding subfield (such as an LDPC/BCC subfield) of 1 or 2 bits, an MCS subfield of 1 bit, a CRC subfield of 4 bits, and a tail subfield of 6 bits. The partial STA-ID subfield may include 4 bits if the length subfield includes 8 bits. Otherwise (if the length subfield includes 9 bits), the partial STA-ID subfield may include 3 bits. In some aspects, the partial STA-ID subfield may convey a last or final 3 or 4 bits of a STA-ID of the intended/addressed receiver of the PPDU 610. For example, the partial STA-ID subfield may indicate the last 3 or 4 least significant bits (LSB) of a full 11-bit STA-ID corresponding to the intended/addressed receiver of the PPDU 610. In accordance with the ELR-SIG field design 950, the ELR-SIG field 620 may exclude a version number subfield and may exclude an uplink/downlink indicator subfield (such as to make room for the partial STA-ID subfield).

In some aspects, and for the ELR-SIG field design 900 or the ELR-SIG field design 950, a resolution of the length subfield may be in units of symbol (such as 4× symbol or an equivalent). An upper limit duration of the data portion 614 or of the ELR-data field 622 may be approximately 4-5.5 milliseconds. The coding subfield of the ELR-SIG field 620 may indicate that a coding associated with the data portion 614 or of the ELR-data field 622 is BCC (such as via a value of “0”), 1×LDPC (648, 1296, 1944) (such as via a value of “1”), or 2×LDPC (3888) (such as via a value of “2”). The MCS subfield of the ELR-SIG field 620 may indicate that the data portion 614 or of the ELR-data field 622 is associated with BPSK with a ½ coding rate (such as via a value of “0”) or quadrature phase shift keying (QPSK) with a ½ coding rate (such as via a value of “1”). BPSK with a ½ coding rate may be associated with a data rate of 1.7 megabits per second (Mbps) and QPSK with a ½ coding rate may be associated with a data rate of 3.4 Mbps.

Further, the ELR-SIG field designs 900 and 950 illustrate example ELR-SIG formats. In some other examples, one or more of the subfields illustrated in the context of the ELR-SIG field design 900 or the ELR-SIG field design 950 may be shortened or skipped. In some aspects, the length subfield may use variable resolution (depending on, for example, one or more of a packet duration, a value indicated by the length subfield, or a quantity of bits within the length subfield).

FIGS. 10A and 10B show example two-symbol ELR-SIG field designs 1000 and 1050, respectively, with separately encoded symbols that support signal field designs for ELR transmissions. In some implementations, the wireless communication device 602 and the wireless communication device 604 may leverage the ELR-SIG field design 1000 or the ELR-SIG field design 1050 to accommodate an early drop at an unintended receiving wireless communication device. Additionally, or alternatively, the wireless communication device 602 and the wireless communication device 604 may leverage the ELR-SIG field design 1000 or the ELR-SIG field design 1050 to provide an intended receiving wireless communication device with information that the intended receiving wireless communication device may use to parse or decode an ELR-data field 622, which may increase a likelihood of successful communication of the PPDU 610, which may in turn increase data rates and network capacity.

The wireless communication device 602 may format the ELR-SIG field 620 of the PPDU 610 in accordance with the ELR-SIG field design 1000 or the ELR-SIG field design 1050, with the ELR-SIG field design 1000 and the ELR-SIG field design 1050 corresponding to two symbol ELR-SIG designs. For example, in accordance with the ELR-SIG field design 1000 or the ELR-SIG field design 1050, the ELR-SIG field 620 of the PPDU 610 may span or include two separately encoded (and separately decoded) symbols. In such examples, the ELR-SIG field 620 may include a first symbol and a second symbol.

In accordance with the ELR-SIG field design 1000, the first symbol may include a STA-ID subfield of 11 bits, an MCS subfield of 1 bit, a coding subfield (such as an LDPC/BCC subfield) of 1 or 2 bits, a reserved bit subfield of 1 bit, a CRC subfield of 4 bits, and a tail subfield of 6 bits. The second symbol may include a version number subfield of 2 bits, a length subfield of 9 bits, a reserved bit subfield of 3 bits, a CRC subfield of 4 bits, and a tail subfield of 6 bits. Thus, in some aspects, the ELR-SIG field design 1000 may be associated with examples in which the ELR-SIG field 620 excludes a BSS color subfield and includes, within the second ELR-SIG field symbol, a 2-bit version number subfield.

In accordance with the ELR-SIG field design 1050, the first symbol may include a version number subfield of 1 bit, a STA-ID subfield of 11 bits, an MCS subfield of 1 bit, a coding subfield of 1 or 2 bits, a CRC subfield of 4 bits, and a tail subfield of 6 bits. The second symbol may include a length subfield of 9 bits, a reserved bit subfield of 5 bits, a CRC subfield of 4 bits, and a tail subfield of 6 bits. Thus, in some aspects, the ELR-SIG field design 1050 may be associated with examples in which the ELR-SIG field 620 excludes a BSS color subfield and includes, within the first ELR-SIG field symbol, a 1-bit version number subfield. In some aspects, the version number subfield may start a field change or interpretation from the first symbol of the two symbols.

In some aspects, and for the ELR-SIG field design 1000 or the ELR-SIG field design 1050, a resolution of the length subfield may be in units of symbol. For example, a value of “0” of the length subfield may indicate that the data portion 614 or of the ELR-data field 622 spans 1 OFDM symbol, a value of “1” of the length subfield may indicate that the data portion 614 or of the ELR-data field 622 spans 2 OFDM symbols, and so on. In such examples, an upper limit length of the data portion 614 or of the ELR-data field 622 may be 373 OFDM symbols (corresponding to a value of “372” of the length subfield) or approximately 5.5 milliseconds in duration. The coding subfield of the ELR-SIG field 620 may indicate that a coding associated with the data portion 614 or of the ELR-data field 622 is BCC (such as via a value of “0”), 1×LDPC (648, 1296, 1944) (such as via a value of “1”), or 2×LDPC (3888) (such as via a value of “2”). The MCS subfield of the ELR-SIG field 620 may indicate that the data portion 614 or of the ELR-data field 622 is associated with BPSK with a ½ coding rate (such as via a value of “0”) or QPSK with a ½ coding rate (such as via a value of “1”). In accordance with the ELR-SIG field design 1000 and the ELR-SIG field design 1050, the bits of the tail subfields (in both symbols) may be set to “0” values.

Further, the ELR-SIG field designs 1000 and 1050 illustrate example ELR-SIG formats. In some other examples, one or more of the subfields illustrated in the context of the ELR-SIG field design 1000 or the ELR-SIG field design 1050 may be shortened or skipped. In some aspects, the length subfield may use variable resolution (depending on, for example, one or more of a packet duration, a value indicated by the length subfield, or a quantity of bits within the length subfield).

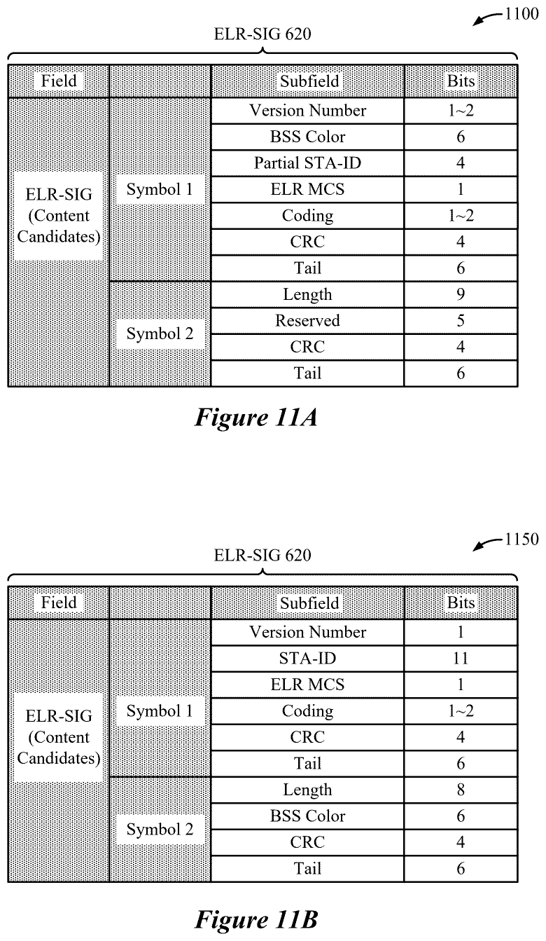

FIGS. 11A and 11B show example two-symbol ELR-SIG field designs 1100 and 1150, respectively, with separately encoded symbols that support signal field designs for ELR transmissions. In some implementations, the wireless communication device 602 and the wireless communication device 604 may leverage the ELR-SIG field design 1100 or the ELR-SIG field design 1150 to accommodate an early drop at an unintended receiving wireless communication device. Additionally, or alternatively, the wireless communication device 602 and the wireless communication device 604 may leverage the ELR-SIG field design 1100 or the ELR-SIG field design 1150 to provide an intended receiving wireless communication device with information that the intended receiving wireless communication device may use to parse or decode an ELR-data field 622, which may increase a likelihood of successful communication of the PPDU 610, which may in turn increase data rates and network capacity.

The wireless communication device 602 may format the ELR-SIG field 620 of the PPDU 610 in accordance with the ELR-SIG field design 1100 or the ELR-SIG field design 1150, with the ELR-SIG field design 1100 and the ELR-SIG field design 1150 corresponding to two symbol ELR-SIG designs. for example, in accordance with the ELR-SIG field design 1100 or the ELR-SIG field design 1150, the ELR-SIG field 620 of the PPDU 610 may span or include two separately encoded (and separately decoded) symbols. In such examples, the ELR-SIG field 620 may include a first symbol and a second symbol.

In accordance with the ELR-SIG field design 1100, the first symbol may include a version number subfield of 1 or 2 bits, a BSS color subfield of 6 bits, a partial STA-ID subfield of 4 bits, an MCS subfield of 1 bit, a coding subfield of 1 or 2 bits, a CRC subfield of 4 bits, and a tail subfield of 6 bits. The second symbol may include a length subfield of 9 bits, a reserved bit subfield of 5 bits, a CRC subfield of 4 bits, and a tail subfield of 6 bits. Thus, in some aspects, the ELR-SIG field design 1100 may be associated with examples in which the ELR-SIG field 620 includes a BSS color subfield, a partial STA-ID subfield, and a 1-bit version number subfield within the first ELR-SIG field symbol.

In accordance with the ELR-SIG field design 1150, the first symbol may include a version number subfield of 1 bit, a STA-ID subfield of 11 bits, an MCS subfield of 1 bit, a coding subfield of 1 or 2 bits, a CRC subfield of 4 bits, and a tail subfield of 6 bits. The second symbol may include a length subfield of 8 bits, a BSS color subfield 6 bits, a CRC subfield of 4 bits, and a tail subfield of 6 bits. Thus, in some aspects, the ELR-SIG field design 1150 may be associated with examples in which the ELR-SIG field 620 includes a BSS color subfield and an 8-bit length subfield within the second ELR-SIG field symbol.

The 9-bit length subfield associated with the ELR-SIG field design 1100 and the 8-bit length subfield associated with the ELR-SIG field design 1150 may each be associated with a resolution in units of symbol. For example, a value of “0” of a length subfield associated with the ELR-SIG field design 1100 or the ELR-SIG field design 1150 may indicate that the data portion 614 or of the ELR-data field 622 spans 1 OFDM symbol, a value of “1” may indicate that the data portion 614 or of the ELR-data field 622 spans 2 OFDM symbols, and so on. A 9-bit length subfield may indicate an upper limit length of the data portion 614 or of the ELR-data field 622 as 373 OFDM symbols (corresponding to a value of “372” of the length subfield) or approximately 5.5 milliseconds in duration. An 8-bit length subfield may indicate an upper limit length of the data portion 614 or of the ELR-data field 622 as 256 OFDM symbols (corresponding to a value of “255” of the length subfield) or approximately 3.7 milliseconds in duration.

In some implementations, the 8-bit length subfield may be associated with a variable resolution. For example, a value “L” of the length subfield in a range of 0-63, the wireless communication device 602 and the wireless communication device 604 may calculate, select, or otherwise determine a (total) quantity of ELR data symbols as in accordance with a first equation. Such a first equation may be, for example, # of ELR data symbols=L+1. Alternatively, for a value “L” of the length subfield in a range of 64-255, the wireless communication device 602 and the wireless communication device 604 may calculate, select, or otherwise determine a (total) quantity of ELR data symbols as in accordance with a second equation. Such a second equation may be, for example, # of ELR data symbols=(L−64)*2+66=2L−62.

The coding subfield of the ELR-SIG field 620 may indicate that a coding associated with the data portion 614 or of the ELR-data field 622 is BCC (such as via a value of “0”), 1×LDPC (648, 1296, 1944) (such as via a value of “1”), or 2×LDPC (3888) (such as via a value of “2”). The MCS subfield of the ELR-SIG field 620 may indicate that the data portion 614 or of the ELR-data field 622 is associated with BPSK with a ½ coding rate (such as via a value of “0”) or QPSK with a ½ coding rate (such as via a value of “1”). In accordance with the ELR-SIG field design 1100 and the ELR-SIG field design 1150, the bits of the tail subfields (in both symbols) may be set to “0” values.

Further, the ELR-SIG field designs 1100 and 1150 illustrate example ELR-SIG formats. In some other examples, one or more of the subfields illustrated in the context of the ELR-SIG field design 1100 or the ELR-SIG field design 1150 may be shortened or skipped. In some aspects, the length subfield may use variable resolution (depending on, for example, one or more of a packet duration, a value indicated by the length subfield, or a quantity of bits within the length subfield).

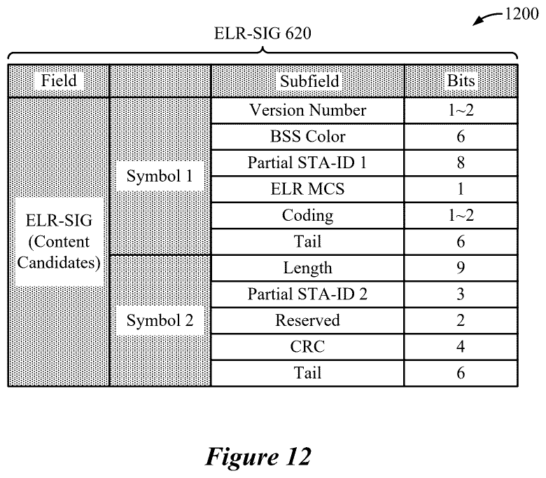

FIG. 12 shows an example two-symbol ELR-SIG field design 1200 with separately encoded symbols that supports signal field designs for ELR transmissions. In some implementations, the wireless communication device 602 and the wireless communication device 604 may leverage the ELR-SIG field design 1200 to accommodate an early drop at an unintended receiving wireless communication device. Additionally, or alternatively, the wireless communication device 602 and the wireless communication device 604 may leverage the ELR-SIG field design 1200 to provide an intended receiving wireless communication device with information that the intended receiving wireless communication device may use to parse or decode an ELR-data field 622, which may increase a likelihood of successful communication of the PPDU 610, which may in turn increase data rates and network capacity.

The wireless communication device 602 may format the ELR-SIG field 620 of the PPDU 610 in accordance with the ELR-SIG field design 1200, with the ELR-SIG field design 1200 corresponding to a two symbol ELR-SIG design. For example, in accordance with the ELR-SIG field design 1200, the ELR-SIG field 620 of the PPDU 610 may span or include two separately encoded (and separately decoded) symbols. In such examples, the ELR-SIG field 620 may include a first symbol and a second symbol.

In accordance with the ELR-SIG field design 1200, the first symbol may include a version number subfield of 1 or 2 bits, a BSS color subfield of 6 bits, a first partial STA-ID subfield (such as a “STA-ID 1” subfield) of 8 bits, an MCS subfield of 1 bit, a coding subfield of 1 or 2 bits, and a tail subfield of 6 bits. The second symbol may include a length subfield of 9 bits, a second partial STA-ID subfield (such as a “STA-ID 2” subfield) of 3 bits, a reserved bit subfield of 2 bits, a CRC subfield of 4 bits, and a tail subfield of 6 bits. The first partial STA-ID subfield may include or indicate the last 8 LSB bits of a STA-ID corresponding to the intended/addressed receiver of the PPDU 610 and the second partial STA-ID subfield may include or indicate the first 3 MSB bits of the STA-ID corresponding to the intended/addressed receiver of the PPDU 610.

In some aspects, the ELR-SIG field design 1200 may be associated with examples in which the ELR-SIG field 620 includes a single CRC subfield for the first and second symbols located within the second symbol (such that the first symbol may exclude a CRC subfield and include only tail bits for BCC), with the STA-ID of the intended/addressed receiver being indicated partially in the first symbol and partially in the second symbol. In such aspects, the ELR-SIG field 620 may be associated with separate encoding across the two symbols with a joint CRC. In other words, a device may use the CRC bits within the CRC subfield that is located within the second symbol of the ELR-SIG field 620 to cover both the first symbol and the second symbol.

In some aspects, and for the ELR-SIG field design 1200, a resolution of the length subfield may be in units of symbol. For example, a value of “0” of the length subfield may indicate that the data portion 614 or of the ELR-data field 622 spans 1 OFDM symbol, a value of “1” of the length subfield may indicate that the data portion 614 or of the ELR-data field 622 spans 2 OFDM symbols, and so on. In such examples, an upper limit length of the data portion 614 or of the ELR-data field 622 may be 373 OFDM symbols (corresponding to a value of “372” of the length subfield) or approximately 5.5 milliseconds in duration. The coding subfield of the ELR-SIG field 620 may indicate that a coding associated with the data portion 614 or of the ELR-data field 622 is BCC (such as via a value of “0”), 1×LDPC (648, 1296, 1944) (such as via a value of “1”), or 2×LDPC (3888) (such as via a value of “2”). The MCS subfield of the ELR-SIG field 620 may indicate that the data portion 614 or of the ELR-data field 622 is associated with BPSK with a ½ coding rate (such as via a value of “0”) or QPSK with a ½ coding rate (such as via a value of “1”). In accordance with the ELR-SIG field design 1200, the bits of the tail subfields (in both symbols) may be set to “0” values.

Further, the ELR-SIG field design 1200 illustrates example ELR-SIG formats. In some other examples, one or more of the subfields illustrated in the context of the ELR-SIG field design 1200 may be shortened or skipped. In some aspects, the length subfield may use variable resolution (depending on, for example, one or more of a packet duration, a value indicated by the length subfield, or a quantity of bits within the length subfield).

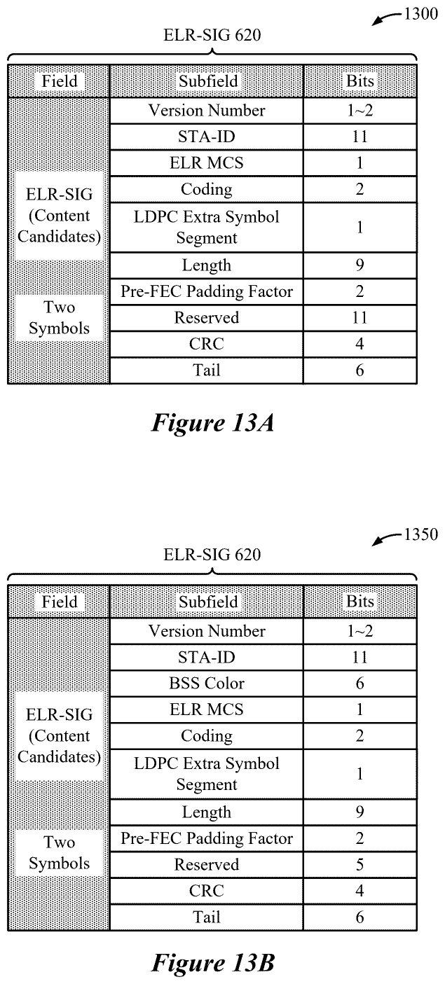

FIGS. 13A and 13B show example two-symbol ELR-SIG field designs 1300 and 1350, respectively, with jointly encoded symbols that support signal field designs for ELR transmissions. In some implementations, the wireless communication device 602 and the wireless communication device 604 may leverage the ELR-SIG field design 1300 or the ELR-SIG field design 1350 to accommodate an early drop at an unintended receiving wireless communication device. Additionally, or alternatively, the wireless communication device 602 and the wireless communication device 604 may leverage the ELR-SIG field design 1300 or the ELR-SIG field design 1350 to provide an intended receiving wireless communication device with information that the intended receiving wireless communication device may use to parse or decode an ELR-data field 622, which may increase a likelihood of successful communication of the PPDU 610, which may in turn increase data rates and network capacity.

The wireless communication device 602 may format the ELR-SIG field 620 of the PPDU 610 in accordance with the ELR-SIG field design 1300 or the ELR-SIG field design 1350, with the ELR-SIG field design 1300 or the ELR-SIG field design 1350 corresponding to two symbol ELR-SIG designs. For example, in accordance with the ELR-SIG field design 1300 or the ELR-SIG field design 1350, the ELR-SIG field 620 of the PPDU 610 may span or include two jointly encoded (and jointly decoded) symbols.

In accordance with the ELR-SIG field design 1300, the ELR-SIG field 620 may include a version number subfield of 1 or 2 bits, a STA-ID subfield of 11 bits, an MCS subfield of 1 bit, a coding subfield of 2 bits, an LDPC extra symbol segment subfield of 1 bit, a length subfield of 9 bits, a pre-forward error correction (FEC) padding factor subfield of 2 bits, a reserved bit subfield of 11 bits, a CRC subfield of 4 bits, and a tail subfield of 6 bits. Accordingly, in such aspects, the ELR-SIG field 620 may exclude a BSS color subfield.

In accordance with the ELR-SIG field design 1350, the ELR-SIG field 620 may include a version number subfield of 1 or 2 bits, a STA-ID subfield of 11 bits, a BSS color subfield of 6 bits, an MCS subfield of 1 bit, a coding subfield of 2 bits, an LDPC extra symbol segment subfield of 1 bit, a length subfield of 9 bits, a pre-FEC padding factor subfield of 2 bits, a reserved bit subfield of 5 bits, a CRC subfield of 4 bits, and a tail subfield of 6 bits. Accordingly, in such aspects, the ELR-SIG field 620 may include a BSS color subfield.

In some aspects, and for the ELR-SIG field design 1300 and the ELR-SIG field design 1350, a resolution of the length subfield may be in units of symbol. For example, a value of “0” of the length subfield may indicate that the data portion 614 or of the ELR-data field 622 spans 1 OFDM symbol, a value of “1” of the length subfield may indicate that the data portion 614 or of the ELR-data field 622 spans 2 OFDM symbols, and so on. In such examples, an upper limit length of the data portion 614 or of the ELR-data field 622 may be 373 OFDM symbols (corresponding to a value of “372” of the length subfield) or approximately 5.5 milliseconds in duration. The coding subfield of the ELR-SIG field 620 may indicate that a coding associated with the data portion 614 or of the ELR-data field 622 is BCC (such as via a value of “0”), 1×LDPC (648, 1296, 1944) (such as via a value of “1”), or 2×LDPC (3888) (such as via a value of “2”). The MCS subfield of the ELR-SIG field 620 may indicate that the data portion 614 or of the ELR-data field 622 is associated with BPSK with a ½ coding rate (such as via a value of “0”) or QPSK with a ½ coding rate (such as via a value of “1”). In accordance with the ELR-SIG field design 1300 and the ELR-SIG field design 1350, the bits of the tail subfield may be set to “0” values. Pre-FEC padding factor subfield values of “0/1/2/3” may correspond or be equal to a pre-FEC padding factor of “4/1/2/3,” respectively.

Further, the ELR-SIG field designs 1300 and 1350 illustrate example ELR-SIG formats. In some other examples, one or more of the subfields illustrated in the context of the ELR-SIG field design 1300 or the ELR-SIG field design 1350 may be shortened or skipped. In some aspects, the length subfield may use variable resolution (depending on, for example, one or more of a packet duration, a value indicated by the length subfield, or a quantity of bits within the length subfield).

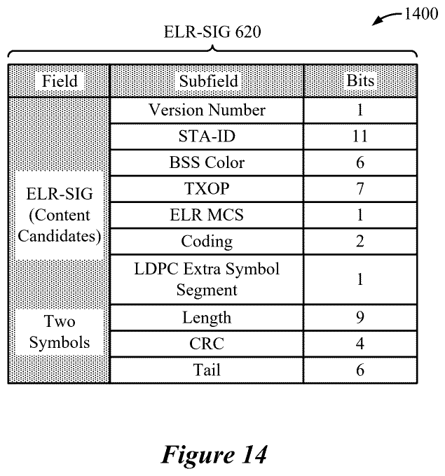

FIG. 14 shows an example two-symbol ELR-SIG field design 1400 with jointly encoded symbols that supports signal field designs for ELR transmissions. In some implementations, the wireless communication device 602 and the wireless communication device 604 may leverage the ELR-SIG field design 1400 to accommodate an early drop at an unintended receiving wireless communication device. Additionally, or alternatively, the wireless communication device 602 and the wireless communication device 604 may leverage the ELR-SIG field design 1400 to provide an intended receiving wireless communication device with information that the intended receiving wireless communication device may use to parse or decode an ELR-data field 622, which may increase a likelihood of successful communication of the PPDU 610, which may in turn increase data rates and network capacity.

The wireless communication device 602 may format the ELR-SIG field 620 of the PPDU 610 in accordance with the ELR-SIG field design 1400, with the ELR-SIG field design 1400 corresponding to a two-symbol ELR-SIG design. For example, in accordance with the ELR-SIG field design 1400, the ELR-SIG field 620 of the PPDU 610 may span or include two jointly encoded (and jointly decoded) symbols.

In accordance with the ELR-SIG field design 1400, the ELR-SIG field 620 may include a version number subfield of 1 bit, a STA-ID subfield of 11 bits, a BSS color subfield of 6 bits, a TXOP subfield of 7 bits, an MCS subfield of 1 bit, a coding subfield of 2 bits, an LDPC extra symbol segment subfield of 1 bit, a length subfield of 9 bits, a CRC subfield of 4 bits, and a tail subfield of 6 bits. Accordingly, in such aspects, the ELR-SIG field 620 may carry or indicate both a BSS color and TXOP-related information.

In some aspects, and for the ELR-SIG field design 1400, a resolution of the length subfield may be in units of symbol. For example, a value of “0” of the length subfield may indicate that the data portion 614 or of the ELR-data field 622 spans 1 OFDM symbol, a value of “1” of the length subfield may indicate that the data portion 614 or of the ELR-data field 622 spans 2 OFDM symbols, and so on. In such examples, an upper limit length of the data portion 614 or of the ELR-data field 622 may be 373 OFDM symbols (corresponding to a value of “372” of the length subfield) or approximately 5.5 milliseconds in duration. The coding subfield of the ELR-SIG field 620 may indicate that a coding associated with the data portion 614 or of the ELR-data field 622 is BCC (such as via a value of “0”), 1×LDPC (648, 1296, 1944) (such as via a value of “1”), or 2×LDPC (3888) (such as via a value of “2”). The MCS subfield of the ELR-SIG field 620 may indicate that the data portion 614 or of the ELR-data field 622 is associated with BPSK with a ½ coding rate (such as via a value of “0”) or QPSK with a ½ coding rate (such as via a value of “1”). In accordance with the ELR-SIG field design 1400, the bits of the tail subfield may be set to “0” values.

Further, the ELR-SIG field design 1400 illustrates example ELR-SIG formats. In some other examples, one or more of the subfields illustrated in the context of the ELR-SIG field design 1400 may be shortened or skipped. In some aspects, the length subfield may use variable resolution (depending on, for example, one or more of a packet duration, a value indicated by the length subfield, or a quantity of bits within the length subfield).

FIG. 15 shows an example rate matching scheme 1500 associated with an ELR-data field of an ELR PPDU. In some implementations, one or both of the wireless communication device 602 and the wireless communication device 604 may support or implement processes associated with the rate matching scheme 1500, which may be an example of a rate matching option for ELR communication. For example, an ELR-data field 622 of the PPDU 610 may be associated with the rate matching scheme 1500, which may increase spectral efficiency by efficiently enabling an ELR PPDU to use a set of available resources for data while balancing ELR-SIG field signaling overhead. As illustrated in the example of the rate matching scheme 1500, one or more OFDM symbols of the ELR-data field 622 may include data bits and initial pre-FEC padding bits 1502, additional pre-FEC padding bits 1504, and PHY coded bits 1506. The rate matching scheme 1500 may be associated with an LDPC extra symbol segment equal to 1.

In accordance with the rate matching scheme 1500, the wireless communication device 602 (or the wireless communication device 604, or both) may apply additional pre-FEC padding so that the pre-FEC padding boundary is at the end of the symbol segment a_{preFEC}=3 of the last symbol in the ELR-data field 622. The quantity of symbols to fit all data bits and pre-FEC padding bits may be defined in accordance with the equation below:

$${N}_{SYM , pre - FEC} = \{ \begin{matrix}{N}_{SYM , init} & if {a}_{init} < 4 \\ {N}_{SYM , init} + 1 & if {a}_{init} = 4\end{matrix}$$

The wireless communication device 602 (or the wireless communication device 604, or both) may calculate, determine, select, or otherwise identify a total quantity of symbols in the ELR-data field 622 in accordance with the equation below:

$${N}_{SYM} = {N}_{SYM , pre - FEC}$$

In some aspects, the Y coded bits boundary may be at the end of the last symbol in the ELR-data field 622, such that a=4 (such that, in some implementations, ELR LDPC rate matching reuses one or more other LDPC rate matching schemes, such as 802.11ac LDPC rate matching). In some aspects, a bit (such as a single bit) may be used (within, for example, the ELR-SIG field 620) to signal the pre-FEC padding boundary. For example, the wireless communication device 602 (or the wireless communication device 604, or both) may use a value “0” to indicate aᵢₙᵢₜ<4 and a value “1” to indicate aᵢₙᵢₜ=4. In the example of the rate matching scheme 1500, the last 1-2 symbols are shown for purpose of example. Each symbol may include 4 symbol segments. The data bits and initial pre-FEC padding bits 1502 may be a minimum or lower limit pre-FEC padding to meet a symbol segment boundary. The boundary of the data bits and initial pre-FEC padding bits 1502 of the rate matching scheme 1500 may be at an end of the symbol segment aᵢₙᵢₜ of the OFDM symbol N_{SYM,init}. The additional pre-FEC padding bits 1504 may be present/included in ELR, so that the pre-FEC padding boundary is at the end of the symbol segment a_{pre-FEC} of the OFDM symbol N_{SYM,pre-FEC}. The PHY coded bits 1506 may be such that a PHY coded bits boundary is at the end of the symbol segment a of the OFDM symbol N_{SYM}.

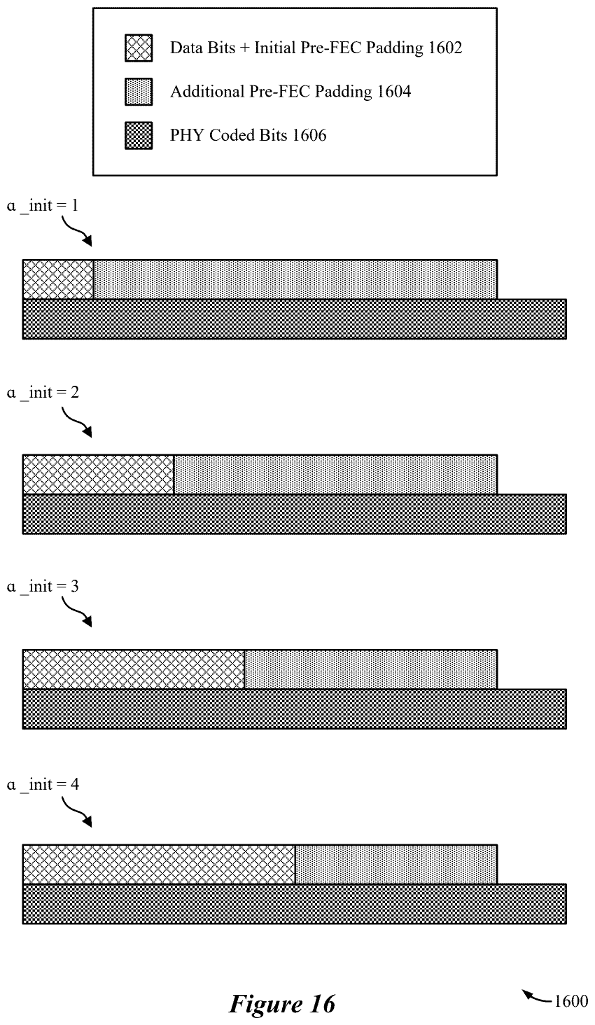

FIG. 16 shows an example rate matching scheme 1600 associated with an ELR-data field of an ELR PPDU. In some implementations, one or both of the wireless communication device 602 and the wireless communication device 604 may support or implement processes associated with the rate matching scheme 1600, which may be an example of a rate matching option for ELR communication. For example, an ELR-data field 622 of the PPDU 610 may be associated with the rate matching scheme 1600, which may increase spectral efficiency by efficiently enabling an ELR PPDU to use a set of available resources for data while balancing ELR-SIG field signaling overhead. As illustrated in the example of the rate matching scheme 1600, one or more OFDM symbols of the ELR-data field 622 may include data bits and initial pre-FEC padding bits 1602, additional pre-FEC padding bits 1604, and PHY coded bits 1606. The rate matching scheme 1600 may be associated with an LDPC extra symbol segment equal to 1.

In accordance with the rate matching scheme 1600, the wireless communication device 602 (or the wireless communication device 604, or both) may apply additional pre-FEC padding so that the pre-FEC padding boundary is at the end of the symbol segment a_{preFEC}=3 of the last symbol in the ELR-data field 622. The quantity of symbols to fit all data bits and pre-FEC padding bits may be defined in accordance with:

$${N}_{SYM , pre - FEC} = {N}_{SYM , init} + 1$$

In some aspects, a quantity of symbols in the ELR-data field 622 may be defined in accordance with:

$${N}_{S Y M} = {N}_{SYM , pre - F E C}$$

In some aspects, the PHY coded bits boundary may be at an end of the last symbol in the ELR-data field 622, such that a=4. In such aspects, the wireless communication device 602 (or the wireless communication device 604, or both) may refrain from transmitting an indication of the pre-FEC padding factor (such that the ELR-SIG field 620 may exclude a pre-FEC padding factor subfield).

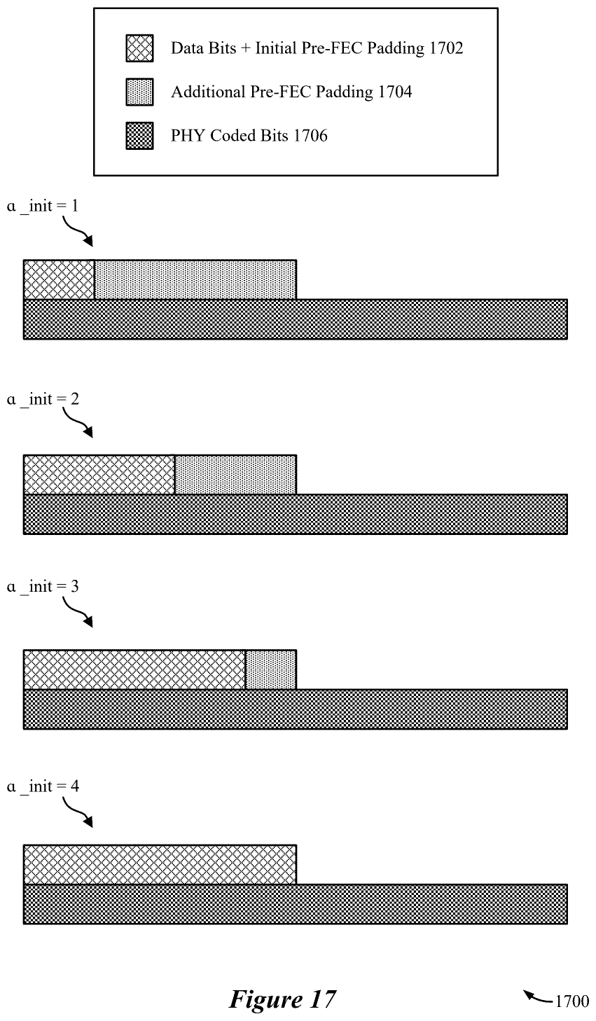

FIG. 17 shows an example rate matching scheme 1700 associated with an ELR-data field of an ELR PPDU. In some implementations, one or both of the wireless communication device 602 and the wireless communication device 604 may support or implement processes associated with the rate matching scheme 1700, which may be an example of a rate matching option for ELR communication. For example, an ELR-data field 622 of the PPDU 610 may be associated with the rate matching scheme 1700, which may increase spectral efficiency by efficiently enabling an ELR PPDU to use a set of available resources for data while balancing ELR-SIG field signaling overhead. As illustrated in the example of the rate matching scheme 1700, one or more OFDM symbols of the ELR-data field 622 may include data bits and initial pre-FEC padding bits 1702, additional pre-FEC padding bits 1704, and PHY coded bits 1706. The rate matching scheme 1700 may be associated with an LDPC extra symbol segment equal to 4.

In accordance with the rate matching scheme 1700, the wireless communication device 602 (or the wireless communication device 604, or both) may apply additional pre-FEC padding so that the pre-FEC padding boundary is at the end of the symbol segment a_{preFEC}=4 of the second to last symbol in the ELR-data field 622. The quantity of symbols to fit all data bits and pre-FEC padding bits may be defined in accordance with:

$${N}_{SYM , pre - F E C} = {N}_{SYM , init}$$

In some aspects, a total quantity of symbols within the ELR-data field 622 may be defined in accordance with:

$${N}_{S Y M} = {N}_{SYM , pre - F E C} + 1$$

In some aspects, the PHY coded bits boundary may be at the end of the last symbol in the ELR-data field 622, such that a=4. In such aspects, the wireless communication device 602 (or the wireless communication device 604, or both) may refrain from transmitting an indication of the pre-FEC padding factor (such that the ELR-SIG field 620 may exclude a pre-FEC padding factor subfield).

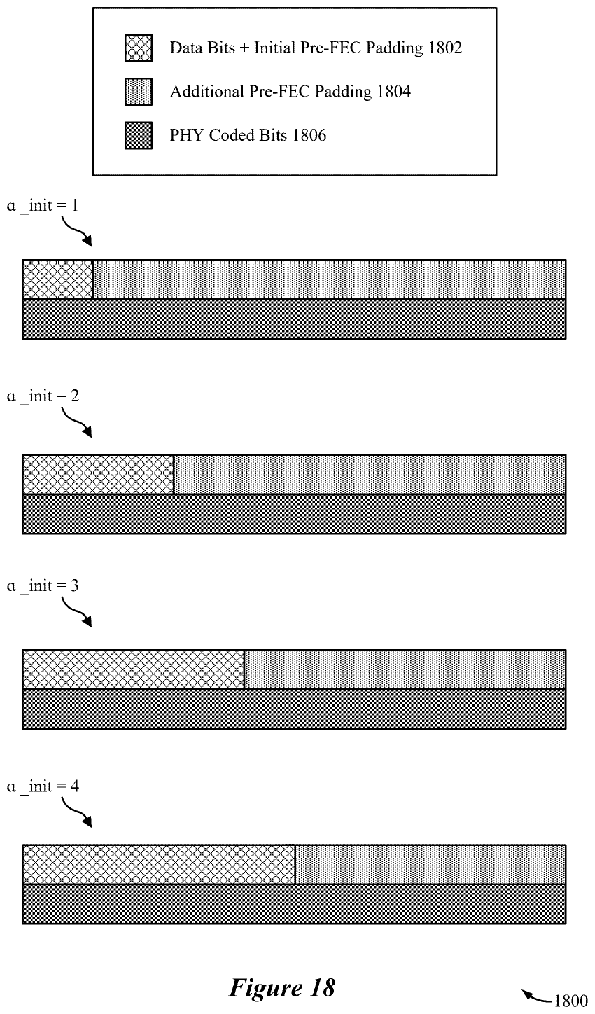

FIG. 18 shows an example rate matching scheme 1800 associated with an ELR-data field of an ELR PPDU. In some implementations, one or both of the wireless communication device 602 and the wireless communication device 604 may support or implement processes associated with the rate matching scheme 1800, which may be an example of a rate matching option for ELR communication. For example, an ELR-data field 622 of the PPDU 610 may be associated with the rate matching scheme 1800, which may increase spectral efficiency by efficiently enabling an ELR PPDU to use a set of available resources for data while balancing ELR-SIG field signaling overhead. As illustrated in the example of the rate matching scheme 1800, one or more OFDM symbols of the ELR-data field 622 may include data bits and initial pre-FEC padding bits 1802, additional pre-FEC padding bits 1804, and PHY coded bits 1806. The rate matching scheme 1800 may be associated with an LDPC extra symbol segment equal to 0.

In accordance with the rate matching scheme 1800, the wireless communication device 602 (or the wireless communication device 604, or both) may apply additional pre-FEC padding so that the pre-FEC padding boundary is at the end of the symbol segment a_{preFEC}=4 of the last symbol in the ELR-data field 622. The quantity of symbols to fit all data bits and pre-FEC padding bits may be defined in accordance with:

$${N}_{SYM , pre - F E C} = {N}_{SYM , init} + 1$$

In some aspects, the total quantity of symbols in the ELR-data field 622 may be defined in accordance with:

$${N}_{S Y M} = {N}_{SYM , pre - F E C}$$

In some aspects, the PHY coded bits boundary may be at the end of the last symbol in the ELR-data field 622, such that a=4. In such aspects, the wireless communication device 602 (or the wireless communication device 604, or both) may refrain from transmitting an indication of the pre-FEC padding factor (such that the ELR-SIG field 620 may exclude a pre-FEC padding factor subfield).

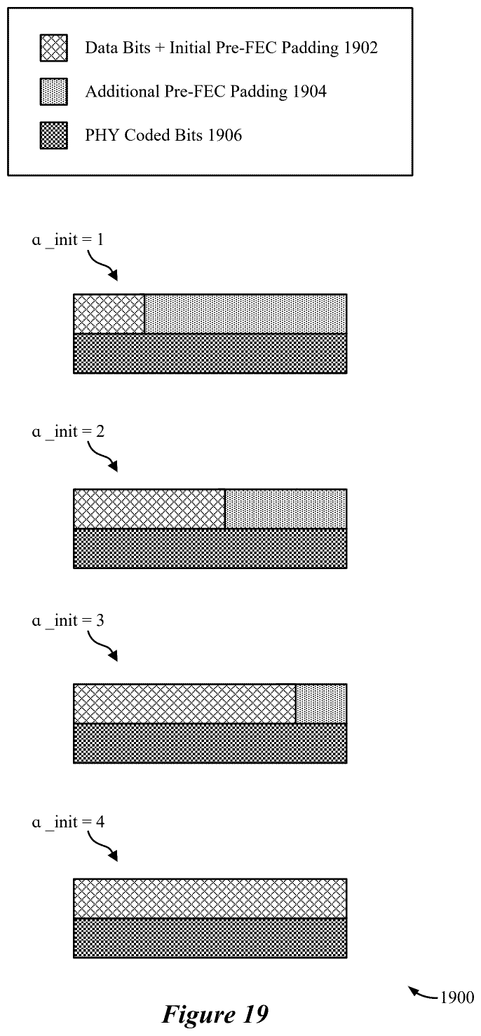

FIG. 19 shows an example rate matching scheme 1900 associated with an ELR-data field of an ELR PPDU. In some implementations, one or both of the wireless communication device 602 and the wireless communication device 604 may support or implement processes associated with the rate matching scheme 1900, which may be an example of a rate matching option for ELR communication. For example, an ELR-data field 622 of the PPDU 610 may be associated with the rate matching scheme 1900, which may increase spectral efficiency by efficiently enabling an ELR PPDU to use a set of available resources for data while balancing ELR-SIG field signaling overhead. As illustrated in the example of the rate matching scheme 1900, one or more OFDM symbols of the ELR-data field 622 may include data bits and initial pre-FEC padding bits 1902, additional pre-FEC padding bits 1904, and PHY coded bits 1906. The rate matching scheme 1900 may be associated with an LDPC extra symbol segment equal to 0.

In accordance with the rate matching scheme 1900, the wireless communication device 602 (or the wireless communication device 604, or both) may apply additional pre-FEC padding so that the pre-FEC padding boundary is at the end of the symbol segment a_{preFEC}=4 of the last symbol in the ELR-data field 622. The quantity of symbols to fit all data bits and pre-FEC padding bits may be defined in accordance with:

$${N}_{SYM , pre - F E C} = {N}_{SYM , init}$$

In some aspects, the total quantity of symbols in the ELR-data field 622 may be defined in accordance with:

$${N}_{S Y M} = {N}_{SYM , pre - F E C}$$

In some aspects, the PHY coded bits boundary may be at the end of the last symbol in the ELR-data field 622, such that a=4. In such aspects, the wireless communication device 602 (or the wireless communication device 604, or both) may refrain from transmitting an indication of the pre-FEC padding factor (such that the ELR-SIG field 620 may exclude a pre-FEC padding factor subfield).

In some implementations, for one or more of the rate matching scheme 1500, the rate matching scheme 1600, the rate matching scheme 1700, the rate matching scheme 1800, or the rate matching scheme 1900, a total quantity of PHY payload bits (such as data bits and pre-FEC padding bits) in a last or final OFDM symbol may be defined in accordance with:

$${N}_{DBPS , last} = \{ \begin{matrix}{a}_{p r e - FEC} \cdot {N}_{DBPS , short} & if & {a}_{p r e - F E C} < 4 \\ {N}_{D B P S} & if & {a}_{p r e - F E C} = 4\end{matrix}$$

In accordance with the rate matching scheme 1500 or the rate matching scheme 1600, the quantity of PHY payload bits becomes:

$${N}_{DBPS , last} = {a}_{pre - FEC} \cdot {N}_{DBPS , short} = 3 \cdot {N}_{DBPS , short}$$

In accordance with the rate matching scheme 1700, the rate matching scheme 1800, or rate matching scheme 1900, the quantity of PHY payload bits becomes:

$${N}_{DBPS , last} = {N}_{D B P S}$$

Further, an initial quantity of coded bits N_{CBPS,last,init} in the last OFDM symbol may be defined in accordance with:

$${N}_{CBPS , last , init} = \{ \begin{matrix}{a}_{p r e - F E C} \cdot {N}_{C BPS , short} & if & {a}_{p r e - F E C} < 4 \\ {N}_{C B P S} & if & {a}_{p r e - F E C} = 4\end{matrix}$$

In some aspects, the parameters N_{pld} and temporary value of N_{avbits} before adding extra symbol segment(s) may be computed using the following equations, respectively.

$$\begin{matrix}{N}_{p l d} = ( {N}_{SYM , pre - F E C} - 1 ) {N}_{D B P S} + {N}_{DBPS , last} \\ {N}_{avbits} = ( {N}_{SYM , p e - F E C} - 1 ) {N}_{C B P S} + {N}_{C BPS , last}\end{matrix}$$

In some aspects, these two parameters may be used to determine an LDPC codeword size and a quantity of LDPC codewords in a second step of an LDPC rate matching process. In some aspects, a total quantity of pre-FEC padding bits may be computed in accordance with:

$${N}_{PAD , Pre - F E C} = ( {N}_{SYM , pre - F E C} - 1 ) {N}_{D B P S} + {N}_{D B P S , last} - 8 \cdot {APEP}_{L E N G T H} - {N}_{s e r v i c e}$$

In accordance with one or more of the rate matching scheme 1500, the rate matching scheme 1600, the rate matching scheme 1700, the rate matching scheme 1800, or the rate matching scheme 1900, and in examples in which a=4, a quantity of coded bits in the last OFDM symbol may be defined in accordance with:

$${N}_{CBPS , last} = {N}_{C B P S}$$

Accordingly, in some aspects, a final total quantity of PHY coded bits may be defined in accordance with:

$${N}_{avbits} = {N}_{S Y M} \cdot {N}_{C B P S}$$

Further, in some implementations, the LDPC rate matching scheme (such as any one or more of the rate matching scheme 1500, the rate matching scheme 1600, the rate matching scheme 1700, the rate matching scheme 1800, or the rate matching scheme 1900) may depend on a size of the Data field (such as an ELR-data field, as indicated by the “Length” field in the ELR-SIG). For example, when the value indicated in the length subfield is smaller than a threshold value, the wireless communication device 602 (or the wireless communication device 604, or both) may use the rate matching scheme 1700. For further example, when the value indicated in the length subfield is equal to or greater than the threshold value, the wireless communication device 602 (or the wireless communication device 604, or both) may use the rate matching scheme 1900.

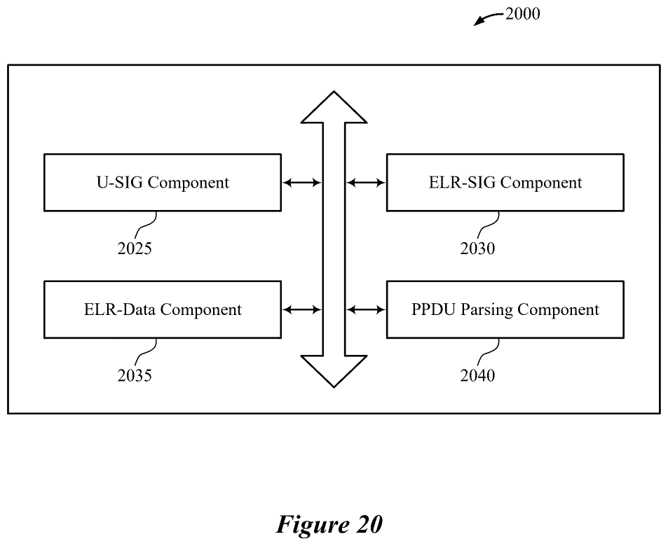

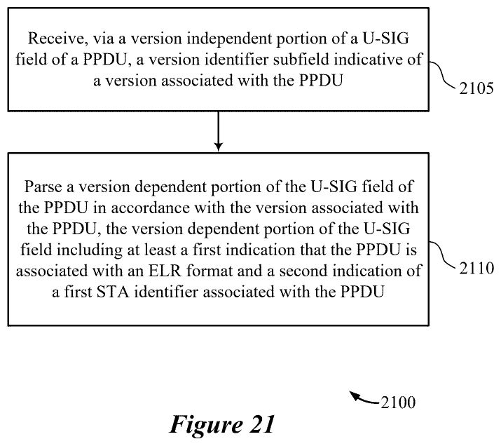

FIG. 20 shows a block diagram of an example wireless communication device 2000 that supports signal field designs for ELR transmissions. In some examples, the wireless communication device 2000 is configured to perform the processes 2100, 2200, 2300, and 2400 described with reference to FIGS. 21, 22, 23, and 24, respectively. The wireless communication device 2000 may include or be one or more chips, SoCs, chipsets, packages, components or devices that individually or collectively constitute or include a processing system. The processing system may interface with other components of the wireless communication device 2000, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 2000 may transmit the information output from the chip. In such an example, the second interface may refer to an interface between the processing system of the chip and a reception component, such that the wireless communication device 2000 may receive information that is passed to the processing system. In some such examples, the first interface also may obtain information, such as from the transmission component, and the second interface also may output information, such as to the reception component.

The processing system of the wireless communication device 2000 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. In some implementations, one or more of the multiple memories may be configured to store processor-executable code that, when executed, may configure one or more of the multiple processors to perform various functions described herein (as part of a processing system). In some other implementations, the processing system may be pre-configured to perform various functions described herein.

Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 2000 can be configurable or configured for use in an AP or STA, such as the AP 102 or the STA 104 described with reference to FIG. 1. In some other examples, the wireless communication device 2000 can be an AP or STA that includes such a processing system and other components including multiple antennas. Additionally, or alternatively, the wireless communication device 2000 can be configurable or configured for use in a wireless communication device 602 or a wireless communication device 604 as illustrated by and described with reference to FIG. 6. In some other examples, the wireless communication device 2000 can be the wireless communication device 602 or the wireless communication device 604 that includes such a processing system and other components including multiple antennas. In some aspects, the wireless communication device 2000 may include an apparatus for wireless communications or may be an example of an apparatus for wireless communications (within, for example, an AP or STA).

The wireless communication device 2000 is capable of transmitting and receiving wireless communications in the form of, for example, wireless packets. For example, the wireless communication device 2000 can be configurable or configured to transmit and receive packets in the form of physical layer PPDUs and MPDUs conforming to one or more of the IEEE 802.11 family of wireless communication protocol standards. In some other examples, the wireless communication device 2000 can be configurable or configured to transmit and receive signals and communications conforming to one or more 3GPP specifications including those for 5G NR or 6G.

In some examples, the wireless communication device 2000 also includes or can be coupled with one or more application processors which may be further coupled with one or more other memories. In some examples, the wireless communication device 2000 further includes a user interface (UI) (such as a touchscreen or keypad) and a display, which may be integrated with the UI to form a touchscreen display that is coupled with the processing system. In some examples, the wireless communication device 2000 may further include one or more sensors such as, for example, one or more inertial sensors, accelerometers, temperature sensors, pressure sensors, or altitude sensors, that are coupled with the processing system. In some examples, the wireless communication device 2000 further includes at least one external network interface coupled with the processing system that enables communication with a core network or backhaul network that enables the wireless communication device 2000 to gain access to external networks including the Internet.

The wireless communication device 2000 includes a U-SIG component 2025, an ELR-SIG component 2030, an ELR-data component 2035, and a PPDU parsing component 2040. Portions of one or more of the U-SIG component 2025, the ELR-SIG component 2030, the ELR-data component 2035, and the PPDU parsing component 2040 may be implemented at least in part in hardware or firmware. For example, one or more of the U-SIG component 2025, the ELR-SIG component 2030, the ELR-data component 2035, and the PPDU parsing component 2040 may be implemented at least in part by at least a processor or a modem. In some examples, portions of one or more of the U-SIG component 2025, the ELR-SIG component 2030, the ELR-data component 2035, and the PPDU parsing component 2040 may be implemented at least in part by a processor and software in the form of processor-executable code stored in memory.

The wireless communication device 2000 may support wireless communication in accordance with examples as disclosed herein. The U-SIG component 2025 is configurable or configured to receive, via a version independent portion of a U-SIG field of a PPDU, a version identifier subfield indicative of a version associated with the PPDU. In some examples, the U-SIG component 2025 is configurable or configured to parse a version dependent portion of the U-SIG field of the PPDU in accordance with the version associated with the PPDU, the version dependent portion of the U-SIG field including at least a first indication that the PPDU is associated with an ELR format and a second indication of a first STA identifier associated with the PPDU.

Additionally, or alternatively, the wireless communication device 2000 may support wireless communication in accordance with examples as disclosed herein. In some examples, the U-SIG component 2025 is configurable or configured to transmit, via a version independent portion of a U-SIG field of a PPDU, a version identifier subfield indicative of a version associated with the PPDU. In some examples, the U-SIG component 2025 is configurable or configured to generate a version dependent portion of the U-SIG field of the PPDU in accordance with the version associated with the PPDU, the version dependent portion of the U-SIG field including a first indication that the PPDU is associated with an ELR format and a second indication of a first STA identifier associated with the PPDU.

In some examples, the version dependent portion of the U-SIG field includes a PPDU type and compression mode subfield. In some examples, the PPDU type and compression mode subfield includes the first indication that the PPDU is associated with the ELR format in accordance with the version associated with the PPDU. In some examples, the PPDU type and compression mode subfield includes a set of multiple bits. In some examples, the first indication that the PPDU is associated with the ELR format corresponds to a codepoint indicated by the set of multiple bits. In some examples, the codepoint corresponds to a value of three. In some examples, the version dependent portion of the U-SIG field includes a spatial reuse subfield, a quantity of vendor-specific bits, and a quantity of reserved bits. In some examples, the spatial reuse subfield includes four bits. In some examples, the quantity of reserved bits is equal to five minus the quantity of vendor-specific bits.

In some examples, the version dependent portion of the U-SIG field includes an ELR subfield in accordance with the version associated with the PPDU. In some examples, the ELR subfield includes the first indication that the PPDU is associated with the ELR format. In some examples, the version dependent portion of the U-SIG field includes a PPDU type and compression mode subfield. In some examples, the PPDU type and compression mode subfield includes reserved bits in accordance with the PPDU being associated with the ELR format. In some examples, the version dependent portion of the U-SIG field includes a spatial reuse subfield, a quantity of vendor-specific bits, and a quantity of reserved bits in addition to the reserved bits within the PPDU type and compression mode subfield. In some examples, the spatial reuse subfield includes four bits. In some examples, the quantity of reserved bits is equal to four minus the quantity of vendor-specific bits.

In some examples, the version dependent portion of the U-SIG field includes a validate bit. In some examples, the first indication that the PPDU is associated with the ELR format corresponds to a value of the validate bit. In some examples, the value of the validate bit is a zero value. In some examples, the validate bit is located immediately prior to a PPDU type and compression mode subfield of the version dependent portion of the U-SIG field.

In some examples, the version dependent portion of the U-SIG field includes a STA identifier subfield in accordance with the version associated with the PPDU. In some examples, the STA identifier subfield includes the second indication of the first STA identifier associated with the PPDU. In some examples, the first STA identifier corresponds to an addressed receiver of the PPDU.

In some examples, the PPDU parsing component 2040 is configurable or configured to selectively parse a remaining portion of the PPDU that follows the U-SIG field in accordance with the first indication and the second indication. In some examples, to support selectively parsing the remaining portion of the PPDU that follows the U-SIG field, the PPDU parsing component 2040 is configurable or configured to parse the remaining portion of the PPDU in accordance with the wireless communication device being an ELR-capable device and a second STA identifier associated with the wireless communication device matching the first STA identifier associated with the PPDU. In some examples, to support selectively parsing the remaining portion of the PPDU that follows the U-SIG field, the PPDU parsing component 2040 is configurable or configured to terminate a parsing process associated with the remaining portion of the PPDU in accordance with the wireless communication device being a non-ELR-capable device or the second STA identifier associated with the wireless communication device being different than the first STA identifier associated with the PPDU.

Additionally, or alternatively, the wireless communication device 2000 may support wireless communication in accordance with examples as disclosed herein. The ELR-SIG component 2030 is configurable or configured to receive, via a preamble portion of a PPDU associated with an ELR format, an ELR-SIG field that includes two symbols, the two symbols collectively including a first set of multiple subfields that includes at least an MCS subfield and a coding subfield associated with a data portion of the PPDU and a second set of multiple subfields that follows the first set of multiple subfields and that includes at least a CRC subfield and a tail subfield. The ELR-data component 2035 is configurable or configured to receive, via the data portion of the PPDU, an ELR-data field in accordance with at least the MCS subfield and the coding subfield.

Additionally, or alternatively, the wireless communication device 2000 may support wireless communication in accordance with examples as disclosed herein. In some examples, the ELR-SIG component 2030 is configurable or configured to transmit, via a preamble portion of a PPDU associated with an ELR format, an ELR-SIG field that includes two symbols, the two symbols collectively including a first set of multiple subfields that includes at least an MCS subfield and a coding subfield associated with a data portion of the PPDU and a second set of multiple subfields that follows the first set of multiple subfields and that includes at least a CRC subfield and a tail subfield. In some examples, the ELR-data component 2035 is configurable or configured to transmit, via the data portion of the PPDU, an ELR-data field in accordance with at least the MCS subfield and the coding subfield.

In some examples, the ELR-data component 2035 is configurable or configured to parse (such as demodulate and decode) or generate (such as modulate and encode) the ELR-data field in accordance with information indicated by the MCS subfield and the coding subfield. In some examples, the ELR-data component 2035 is configurable or configured to configure one or more components of the wireless communication device associated with data reception processing in accordance with the information indicated by the MCS subfield and the coding subfield, the ELR-data field being parsed in accordance with configuring the one or more components associated with the data reception processing.

In some examples, the first set of multiple subfields further includes a STA identifier subfield indicative of at least a portion of a first STA identifier associated with the PPDU. In some examples, the first STA identifier corresponds to an addressed receiver of the PPDU. In some examples, the wireless communication device parses the ELR-data field in accordance with at least a portion of a second STA identifier associated with the wireless communication device matching at least the portion of the first STA identifier associated with the PPDU.

In some examples, the two symbols of the ELR-SIG field include a first symbol and a second symbol, and the ELR-SIG component 2030 is configurable or configured to decode or encode the first symbol and the second symbol separately, the first symbol including the first set of multiple subfields and the second symbol including the second set of multiple subfields.

In some examples, the two symbols of the ELR-SIG field exclude a BSS color subfield. In some examples, the second symbol includes a two-bit version number subfield. In some examples, the first symbol includes a one-bit version number subfield and the second symbol includes a nine-bit length subfield. In some examples, the first symbol includes a BSS color subfield, a partial STA identifier subfield, and a one-bit version number subfield. In some examples, the second symbol includes a BSS color subfield and an eight-bit length subfield.

In some examples, to support decoding or encoding the first symbol and the second symbol separately, the ELR-SIG component 2030 is configurable or configured to decode or encode the first symbol of the ELR-SIG field in accordance with a first set of multiple CRC bits within the first symbol. In some examples, to support decoding or encoding the first symbol and the second symbol separately, the ELR-SIG component 2030 is configurable or configured to decode or encode the second symbol of the ELR-SIG field in accordance with a second set of multiple CRC bits within the second symbol. In some examples, the CRC subfield within the second set of multiple subfields includes the second set of multiple CRC bits. In some examples, another CRC subfield within the first set of multiple subfields includes the first set of multiple CRC bits.

In some examples, to support decoding or encoding the first symbol and the second symbol separately, the ELR-SIG component 2030 is configurable or configured to decode or encode the first symbol of the ELR-SIG field in accordance with a set of multiple CRC bits within the second symbol. In some examples, to support decoding or encoding the first symbol and the second symbol separately, the ELR-SIG component 2030 is configurable or configured to decode or encode the second symbol of the ELR-SIG field in accordance with the set of multiple CRC bits within the second symbol. In some examples, the CRC subfield within the second set of multiple subfields includes the set of multiple CRC bits. In some examples, the first symbol and the second symbol each includes a respective set of multiple tail bits. In some examples, the first symbol excludes CRC bits.

In some examples, the first symbol includes a first partial STA identifier subfield indicative of a first portion of a first STA identifier associated with the PPDU. In some examples, the second symbol includes a second partial STA identifier subfield indicative of a second portion of the first STA identifier associated with the PPDU. In some examples, the second symbol includes a nine-bit length subfield.

In some examples, the ELR-SIG component 2030 is configurable or configured to decode or encode the two symbols of the ELR-SIG field jointly to obtain the first set of multiple subfields and the second set of multiple subfields.

In some examples, the two symbols of the ELR-SIG field exclude a BSS color subfield. In some examples, the first set of multiple subfields further includes a one- or two-bit version number subfield. In some examples, the first set of multiple subfields further includes a BSS color subfield and a one- or two-bit version number subfield. In some examples, the first set of multiple subfields further includes a BSS color subfield, a TXOP subfield, and a one-bit version number subfield.

In some examples, the first set of multiple subfields or the second set of multiple subfields further includes a length subfield. In some examples, the length subfield indicates a quantity of OFDM symbols associated with the data portion of the PPDU. In some examples, a resolution of the quantity of OFDM symbols indicated by the length subfield is in accordance with one or both of a quantity of bits within the length subfield and a length of the PPDU. In some examples, the length subfield includes nine bits. In some examples, the resolution is equal to one symbol. In some examples, the length subfield includes seven bits. In some examples, the resolution is equal to one symbol in accordance with the length of the PPDU being less than a threshold quantity of OFDM symbols and is equal to two symbols in accordance with the length of the PPDU being greater than or equal to the threshold quantity of OFDM symbols.

In some examples, a resolution of the quantity of OFDM symbols indicated by the length subfield is variable in accordance with a value of the length subfield. In some examples, the length subfield includes eight bits. In some examples, the quantity of OFDM symbols associated with the data portion of the PPDU is associated with a first equation in accordance with the value indicated by the length subfield being within a first set of multiple values and is associated with a second equation in accordance with the value indicated by the length subfield being within a second set of multiple values.

FIG. 21 shows a flowchart illustrating an example process 2100 performable by or at a wireless communication device that supports signal field designs for ELR transmissions. The operations of the process 2100 may be implemented by a wireless communication device or its components as described herein. For example, the process 2100 may be performed by a wireless communication device, such as the wireless communication device 2000 described with reference to FIG. 20, operating as or within a wireless AP or a wireless STA. In some examples, the process 2100 may be performed by a wireless AP or a wireless STA, such as one of the APs 102 or the STAs 104 described with reference to FIG. 1.

In some examples, in 2105, the wireless communication device may receive, via a version independent portion of a U-SIG field of a PPDU, a version identifier subfield indicative of a version associated with the PPDU. The operations of 2105 may be performed in accordance with examples as disclosed herein. In some implementations, aspects of the operations of 2105 may be performed by a U-SIG component 2025 as described with reference to FIG. 20.

In some examples, in 2110, the wireless communication device may parse a version dependent portion of the U-SIG field of the PPDU in accordance with the version associated with the PPDU, the version dependent portion of the U-SIG field including at least a first indication that the PPDU is associated with an ELR format and a second indication of a first STA identifier associated with the PPDU. The operations of 2110 may be performed in accordance with examples as disclosed herein. In some implementations, aspects of the operations of 2110 may be performed by a U-SIG component 2025 as described with reference to FIG. 20.

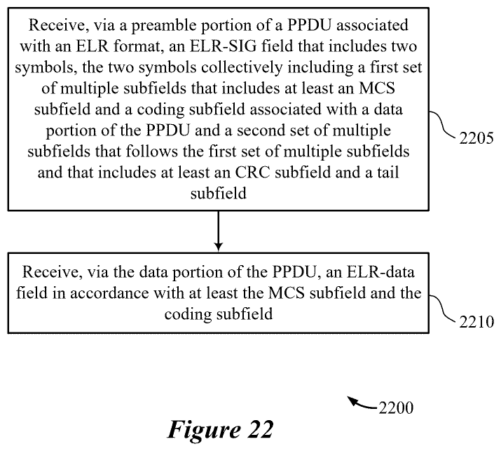

FIG. 22 shows a flowchart illustrating an example process 2200 performable by or at a wireless communication device that supports signal field designs for ELR transmissions. The operations of the process 2200 may be implemented by a wireless communication device or its components as described herein. For example, the process 2200 may be performed by a wireless communication device, such as the wireless communication device 2000 described with reference to FIG. 20, operating as or within a wireless AP or a wireless STA. In some examples, the process 2200 may be performed by a wireless AP or a wireless STA, such as one of the APs 102 or the STAs 104 described with reference to FIG. 1.

In some examples, in 2205, the wireless communication device may receive, via a preamble portion of a PPDU associated with an ELR format, an ELR-SIG field that includes two symbols, the two symbols collectively including a first set of multiple subfields that includes at least an MCS subfield and a coding subfield associated with a data portion of the PPDU and a second set of multiple subfields that follows the first set of multiple subfields and that includes at least an CRC subfield and a tail subfield. The operations of 2205 may be performed in accordance with examples as disclosed herein. In some implementations, aspects of the operations of 2205 may be performed by an ELR-SIG component 2030 as described with reference to FIG. 20.

In some examples, in 2210, the wireless communication device may receive, via the data portion of the PPDU, an ELR-data field in accordance with at least the MCS subfield and the coding subfield. The operations of 2210 may be performed in accordance with examples as disclosed herein. In some implementations, aspects of the operations of 2210 may be performed by an ELR-data component 2035 as described with reference to FIG. 20.

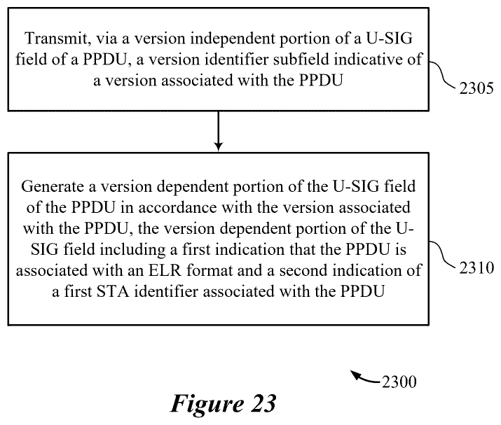

FIG. 23 shows a flowchart illustrating an example process 2300 performable by or at a wireless communication device that supports signal field designs for ELR transmissions. The operations of the process 2300 may be implemented by a wireless communication device or its components as described herein. For example, the process 2300 may be performed by a wireless communication device, such as the wireless communication device 2000 described with reference to FIG. 20, operating as or within a wireless AP or a wireless STA. In some examples, the process 2300 may be performed by a wireless AP or a wireless STA, such as one of the APs 102 or the STAs 104 described with reference to FIG. 1.

In some examples, in 2305, the wireless communication device may transmit, via a version independent portion of a U-SIG field of a PPDU, a version identifier subfield indicative of a version associated with the PPDU. The operations of 2305 may be performed in accordance with examples as disclosed herein. In some implementations, aspects of the operations of 2305 may be performed by a U-SIG component 2025 as described with reference to FIG. 20.

In some examples, in 2310, the wireless communication device may generate a version dependent portion of the U-SIG field of the PPDU in accordance with the version associated with the PPDU, the version dependent portion of the U-SIG field including a first indication that the PPDU is associated with an ELR format and a second indication of a first STA identifier associated with the PPDU. The operations of 2310 may be performed in accordance with examples as disclosed herein. In some implementations, aspects of the operations of 2310 may be performed by a U-SIG component 2025 as described with reference to FIG. 20.

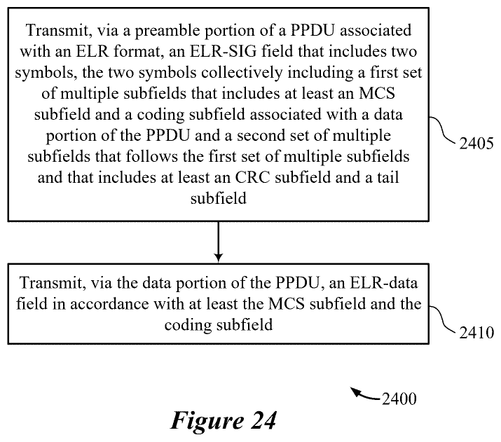

FIG. 24 shows a flowchart illustrating an example process 2400 performable by or at a wireless communication device that supports signal field designs for ELR transmissions. The operations of the process 2400 may be implemented by a wireless communication device or its components as described herein. For example, the process 2400 may be performed by a wireless communication device, such as the wireless communication device 2000 described with reference to FIG. 20, operating as or within a wireless AP or a wireless STA. In some examples, the process 2400 may be performed by a wireless AP or a wireless STA, such as one of the APs 102 or the STAs 104 described with reference to FIG. 1.

In some examples, in 2405, the wireless communication device may transmit, via a preamble portion of a PPDU associated with an ELR format, an ELR-SIG field that includes two symbols, the two symbols collectively including a first set of multiple subfields that includes at least an MCS subfield and a coding subfield associated with a data portion of the PPDU and a second set of multiple subfields that follows the first set of multiple subfields and that includes at least an CRC subfield and a tail subfield. The operations of 2405 may be performed in accordance with examples as disclosed herein. In some implementations, aspects of the operations of 2405 may be performed by an ELR-SIG component 2030 as described with reference to FIG. 20.

In some examples, in 2410, the wireless communication device may transmit, via the data portion of the PPDU, an ELR-data field in accordance with at least the MCS subfield and the coding subfield. The operations of 2410 may be performed in accordance with examples as disclosed herein. In some implementations, aspects of the operations of 2410 may be performed by an ELR-data component 2035 as described with reference to FIG. 20.

Implementation examples are described in the following numbered clauses:

Clause 1: A method for wireless communication at a wireless communication device, including: receiving, via a version independent portion of a U-SIG field of a PPDU, a version identifier subfield indicative of a version associated with the PPDU; and parsing a version dependent portion of the U-SIG field of the PPDU in accordance with the version associated with the PPDU, the version dependent portion of the U-SIG field including at least a first indication that the PPDU is associated with an ELR format and a second indication of a first STA-ID associated with the PPDU.

Clause 2: The method of clause 1, where the version dependent portion of the U-SIG field includes a PPDU type and compression mode subfield, and the PPDU type and compression mode subfield includes the first indication that the PPDU is associated with the ELR format in accordance with the version associated with the PPDU.

Clause 3: The method of clause 2, where the PPDU type and compression mode subfield includes a plurality of bits, and the first indication that the PPDU is associated with the ELR format corresponds to a codepoint indicated by the plurality of bits.

Clause 4: The method of clause 3, where the codepoint corresponds to a value of three.

Clause 5: The method of any of clauses 2-4, where the version dependent portion of the U-SIG field includes a spatial reuse subfield, a quantity of vendor-specific bits, and a quantity of reserved bits, the spatial reuse subfield includes four bits, and the quantity of reserved bits is equal to five minus the quantity of vendor-specific bits.

Clause 6: The method of any of clauses 1-5, where the version dependent portion of the U-SIG field includes an ELR subfield in accordance with the version associated with the PPDU, and the ELR subfield includes the first indication that the PPDU is associated with the ELR format.

Clause 7: The method of clause 6, where the version dependent portion of the U-SIG field includes a PPDU type and compression mode subfield, and the PPDU type and compression mode subfield includes reserved bits in accordance with the PPDU being associated with the ELR format.

Clause 8: The method of clause 7, where the version dependent portion of the U-SIG field includes a spatial reuse subfield, a quantity of vendor-specific bits, and a quantity of reserved bits in addition to the reserved bits within the PPDU type and compression mode subfield, the spatial reuse subfield includes four bits, and the quantity of reserved bits is equal to four minus the quantity of vendor-specific bits.

Clause 9: The method of any of clauses 1-8, where the version dependent portion of the U-SIG field includes a validate bit, and the first indication that the PPDU is associated with the ELR format corresponds to a value of the validate bit.

Clause 10: The method of clause 9, where the value of the validate bit is a zero value.

Clause 11: The method of any of clauses 9-10, where the validate bit is located immediately prior to a PPDU type and compression mode subfield of the version dependent portion of the U-SIG field.

Clause 12: The method of any of clauses 1-11, where the version dependent portion of the U-SIG field includes a STA-ID subfield in accordance with the version associated with the PPDU, the STA-ID subfield includes the second indication of the first STA-ID associated with the PPDU, and the first STA-ID corresponds to an addressed receiver of the PPDU.

Clause 13: The method of any of clauses 1-12, further including: selectively parsing a remaining portion of the PPDU that follows the U-SIG field in accordance with the first indication and the second indication.

Clause 14: The method of clause 13, where selectively parsing the remaining portion of the PPDU that follows the U-SIG field includes: parsing the remaining portion of the PPDU in accordance with the wireless communication device being an ELR-capable device and a second STA-ID associated with the wireless communication device matching the first STA-ID associated with the PPDU; or terminating a parsing process associated with the remaining portion of the PPDU in accordance with the wireless communication device being a non-ELR-capable device or the second STA-ID associated with the wireless communication device being different than the first STA-ID associated with the PPDU.

Clause 15: A method for wireless communication at a wireless communication device, including: receiving, via a preamble portion of a PPDU associated with an ELR format, an ELR-SIG field that includes two symbols, the two symbols collectively including a first plurality of subfields that includes at least an MCS subfield and a coding subfield associated with a data portion of the PPDU and a second plurality of subfields that follows the first plurality of subfields and that includes at least a CRC subfield and a tail subfield; and receiving, via the data portion of the PPDU, an ELR-data field in accordance with at least the MCS subfield and the coding subfield.

Clause 16: The method of clause 15, further including: parsing the ELR-data field in accordance with information indicated by the MCS subfield and the coding subfield.

Clause 17: The method of clause 16, further including: configuring one or more components of the wireless communication device associated with data reception processing in accordance with the information indicated by the MCS subfield and the coding subfield, the ELR-data field being parsed in accordance with configuring the one or more components associated with the data reception processing.

Clause 18: The method of any of clauses 16-17, where the first plurality of subfields further includes a STA-ID subfield indicative of at least a portion of a first STA-ID associated with the PPDU, the first STA-ID corresponds to an addressed receiver of the PPDU, and the wireless communication device parses the ELR-data field in accordance with at least a portion of a second STA-ID associated with the wireless communication device matching at least the portion of the first STA-ID associated with the PPDU.

Clause 19: The method of any of clauses 15-18, where the two symbols of the ELR-SIG field include a first symbol and a second symbol, the method further including: decoding the first symbol and the second symbol separately, the first symbol including the first plurality of subfields and the second symbol including the second plurality of subfields.

Clause 20: The method of clause 19, where the two symbols of the ELR-SIG field exclude a BSS color subfield, and the second symbol includes a two-bit version number subfield.

Clause 21: The method of any of clauses 19-20, where the two symbols of the ELR-SIG field exclude a BSS color subfield, and the first symbol includes a one-bit version number subfield and the second symbol includes a nine-bit length subfield.

Clause 22: The method of any of clauses 19-21, where the first symbol includes a BSS color subfield, a partial STA-ID subfield, and a one-bit version number subfield.

Clause 23: The method of any of clauses 19-22, where the second symbol includes a BSS color subfield and an eight-bit length subfield.

Clause 24: The method of any of clauses 19-23, where decoding the first symbol and the second symbol separately includes: decoding the first symbol of the ELR-SIG field in accordance with a first plurality of CRC bits within the first symbol; and decoding the second symbol of the ELR-SIG field in accordance with a second plurality of CRC bits within the second symbol.

Clause 25: The method of clause 24, where the CRC subfield within the second plurality of subfields includes the second plurality of CRC bits, and another CRC subfield within the first plurality of subfields includes the first plurality of CRC bits.

Clause 26: The method of any of clauses 19-25, where decoding the first symbol and the second symbol separately includes: decoding the first symbol of the ELR-SIG field in accordance with a plurality of CRC bits within the second symbol; and decoding the second symbol of the ELR-SIG field in accordance with the plurality of CRC bits within the second symbol.

Clause 27: The method of clause 26, where the CRC subfield within the second plurality of subfields includes the plurality of CRC bits.

Clause 28: The method of any of clauses 26-27, where the first symbol and the second symbol each includes a respective plurality of tail bits, and the first symbol excludes CRC bits.

Clause 29: The method of any of clauses 19-28, where the first symbol includes a first partial STA-ID subfield indicative of a first portion of a first STA-ID associated with the PPDU, and the second symbol includes a second partial STA-ID subfield indicative of a second portion of the first STA-ID associated with the PPDU.

Clause 30: The method of clause 29, where the second symbol includes a nine-bit length subfield.

Clause 31: The method of any of clauses 15-30, further including: decoding the two symbols of the ELR-SIG field jointly to obtain the first plurality of subfields and the second plurality of subfields.

Clause 32: The method of clause 31, where the two symbols of the ELR-SIG field exclude a BSS color subfield, and the first plurality of subfields further includes a one- or two-bit version number subfield.

Clause 33: The method of any of clauses 31-32, where the first plurality of subfields further includes a BSS color subfield and a one- or two-bit version number subfield.

Clause 34: The method of any of clauses 31-33, where the first plurality of subfields further includes a BSS color subfield, a TXOP subfield, and a one-bit version number subfield.

Clause 35: The method of any of clauses 15-34, where the first plurality of subfields or the second plurality of subfields further includes a length subfield, and the length subfield indicates a quantity of orthogonal frequency division multiplexing (OFDM) symbols associated with the data portion of the PPDU.

Clause 36: The method of clause 35, where a resolution of the quantity of OFDM symbols indicated by the length subfield is in accordance with one or both of a quantity of bits within the length subfield and a length of the PPDU.

Clause 37: The method of any of clauses 35-36, where the length subfield includes nine bits, and the resolution is equal to one symbol.

Clause 38: The method of any of clauses 35-36, where the length subfield includes seven bits, and the resolution is equal to one symbol in accordance with the length of the PPDU being less than a threshold quantity of OFDM symbols and is equal to two symbols in accordance with the length of the PPDU being greater than or equal to the threshold quantity of OFDM symbols.

Clause 39: The method of any of clauses 35-38, where a resolution of the quantity of OFDM symbols indicated by the length subfield is variable in accordance with a value of the length subfield.

Clause 40: The method of clause 39, where the length subfield includes eight bits, and the quantity of OFDM symbols associated with the data portion of the PPDU is associated with a first equation in accordance with the value indicated by the length subfield being within a first plurality of values and is associated with a second equation in accordance with the value indicated by the length subfield being within a second plurality of values.

Clause 41: A method for wireless communication at a wireless communication device, including: transmitting, via a version independent portion of a U-SIG field of a PPDU, a version identifier subfield indicative of a version associated with the PPDU; and generating a version dependent portion of the U-SIG field of the PPDU in accordance with the version associated with the PPDU, the version dependent portion of the U-SIG field including a first indication that the PPDU is associated with an ELR format and a second indication of a first STA-ID associated with the PPDU, where the wireless communication device may further support, enable, facilitate, configure, accommodate, or (directly or indirectly) cause a method of any of clauses 1-14.

Clause 42: A method for wireless communication at a wireless communication device, including: transmitting, via a preamble portion of a PPDU associated with an ELR format, an ELR-SIG field that includes two symbols, the two symbols collectively including a first plurality of subfields that includes at least a MCS subfield and a coding subfield associated with a data portion of the PPDU and a second plurality of subfields that follows the first plurality of subfields and that includes at least a CRC subfield and a tail subfield; and transmitting, via the data portion of the PPDU, an ELR-data field in accordance with at least the MCS subfield and the coding subfield, where the wireless communication device may further support, enable, facilitate, configure, accommodate, or (directly or indirectly) cause a method of any of clauses 15-40.

Clause 43: An apparatus for wireless communications at a wireless communication device, including a processing system that includes processor circuitry and memory circuitry that stores code, the processing system configured to cause the apparatus to perform a method of any of clauses 1-14.

Clause 44: An apparatus for wireless communications at a wireless communication device, including at least one means for performing a method of any of clauses 1-14.

Clause 45: A non-transitory computer-readable medium storing code for wireless communication, the code including instructions executable by one or more processors to perform a method of any of clauses 1-14.

Clause 46: An apparatus for wireless communications at a wireless communication device, including a processing system that includes processor circuitry and memory circuitry that stores code, the processing system configured to cause the apparatus to perform a method of any of clauses 15-40.

Clause 47: An apparatus for wireless communications at a wireless communication device, including at least one means for performing a method of any of clauses 15-40.

Clause 48: A non-transitory computer-readable medium storing code for wireless communication, the code including instructions executable by one or more processors to perform a method of any of clauses 15-40.

Clause 49: An apparatus for wireless communications at a wireless communication device, including a processing system that includes processor circuitry and memory circuitry that stores code, the processing system configured to cause the apparatus to perform the method of clause 41, where the apparatus may further support, enable, facilitate, configure, accommodate, or (directly or indirectly) cause a method of any of clauses 1-14.

Clause 50: An apparatus for wireless communications at a wireless communication device, including at least one means for performing the method of clause 41, where the apparatus may further support, enable, facilitate, configure, accommodate, or (directly or indirectly) cause a method of any of clauses 1-14.

Clause 51: A non-transitory computer-readable medium storing code for wireless communication, the code including instructions executable by one or more processors to perform the method of clause 41, where the apparatus may further support, enable, facilitate, configure, accommodate, or (directly or indirectly) cause a method of any of clauses 1-14.

Clause 52: An apparatus for wireless communications at a wireless communication device, including a processing system that includes processor circuitry and memory circuitry that stores code, the processing system configured to cause the apparatus to perform the method of clause 42, where the apparatus may further support, enable, facilitate, configure, accommodate, or (directly or indirectly) cause a method of any of clauses 15-40.

Clause 53: An apparatus for wireless communications at a wireless communication device, including at least one means for performing the method of clause 42, where the apparatus may further support, enable, facilitate, configure, accommodate, or (directly or indirectly) cause a method of any of clauses 15-40.

Clause 54: A non-transitory computer-readable medium storing code for wireless communication, the code including instructions executable by one or more processors to perform the method of clause 42, where the apparatus may further support, enable, facilitate, configure, accommodate, or (directly or indirectly) cause a method of any of clauses 15-40.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus for wireless communications at a wireless communication device, comprising:
a processing system that comprises processor circuitry and memory circuitry that stores code, the processing system configured to cause the apparatus to:
receive, via a version independent portion of a universal signal (U-SIG) field of a physical layer (PHY) protocol data unit (PPDU), a version identifier subfield indicative of a version associated with the PPDU; and
parse a version dependent portion of the U-SIG field of the PPDU in accordance with the version associated with the PPDU, the version dependent portion of the U-SIG field comprising at least a first indication that the PPDU is associated with an enhanced long range (ELR) format and a second indication of a first station (STA) identifier associated with the PPDU.

2. The apparatus of claim 1, wherein:
the version dependent portion of the U-SIG field comprises a PPDU type and compression mode subfield, and
the PPDU type and compression mode subfield comprises the first indication that the PPDU is associated with the ELR format in accordance with the version associated with the PPDU.

3. The apparatus of claim 2, wherein:
the PPDU type and compression mode subfield comprises a plurality of bits, and
the first indication that the PPDU is associated with the ELR format corresponds to a codepoint indicated by the plurality of bits.

4. The apparatus of claim 3, wherein the codepoint corresponds to a value of three.

5. The apparatus of claim 1, wherein:
the version identifier subfield comprises three bits indicative of a codepoint corresponding to a value of one, and
the codepoint corresponding to the value of one indicates that the version associated with the PPDU is ultra-high reliability (UHR).

6. The apparatus of claim 1, wherein:
the version dependent portion of the U-SIG field comprises a STA identifier subfield in accordance with the version associated with the PPDU,
the STA identifier subfield comprises the second indication of the first STA identifier associated with the PPDU, and
the first STA identifier corresponds to an addressed receiver of the PPDU.

7. The apparatus of claim 1, wherein the processing system is further configured to cause the apparatus to:
selectively parse a remaining portion of the PPDU that follows the U-SIG field in accordance with the first indication and the second indication.

8. An apparatus for wireless communications at a wireless communication device, comprising:
a processing system that comprises processor circuitry and memory circuitry that stores code, the processing system configured to cause the apparatus to:
receive, via a preamble portion of a physical layer (PHY) protocol data unit (PPDU) associated with an enhanced long range (ELR) format, an ELR-signal (ELR-SIG) field that comprises two symbols, the two symbols collectively comprising a first plurality of subfields that comprises at least a modulation and coding scheme (MCS) subfield and a coding subfield associated with a data portion of the PPDU and a second plurality of subfields that follows the first plurality of subfields and that comprises at least a cyclic redundancy check (CRC) subfield and a tail subfield; and
receive, via the data portion of the PPDU, an ELR-data field in accordance with at least the MCS subfield and the coding subfield.

9. The apparatus of claim 8, wherein the processing system is further configured to cause the apparatus to:
parse the ELR-data field in accordance with information indicated by the MCS subfield and the coding subfield.

10. The apparatus of claim 8, wherein the two symbols of the ELR-SIG field comprise a first symbol and a second symbol, and the processing system is further configured to cause the apparatus to:
decode the first symbol and the second symbol separately, the first symbol comprising the first plurality of subfields and the second symbol comprising the second plurality of subfields.

11. The apparatus of claim 10, wherein, to decode the first symbol and the second symbol separately, the processing system is configured to cause the apparatus to:
decode the first symbol of the ELR-SIG field in accordance with a first plurality of CRC bits within the first symbol; and
decode the second symbol of the ELR-SIG field in accordance with a second plurality of CRC bits within the second symbol.

12. The apparatus of claim 11, wherein:
the CRC subfield within the second plurality of subfields comprises the second plurality of CRC bits, and
another CRC subfield within the first plurality of subfields comprises the first plurality of CRC bits.

13. The apparatus of claim 8, wherein the first symbol comprises a first plurality of tail bits and the second symbol comprises a second plurality of tail bits.

14. The apparatus of claim 8, wherein:
the first plurality of subfields or the second plurality of subfields further comprises a length subfield, and
the length subfield indicates a quantity of orthogonal frequency division multiplexing (OFDM) symbols associated with the data portion of the PPDU.

15. The apparatus of claim 14, wherein:
the length subfield comprises nine bits, and
a resolution of the quantity of OFDM symbols indicated by the length subfield is equal to one symbol.

16. The apparatus of claim 8, wherein the preamble portion of the PPDU further comprises an ELR-long training field (ELR-LTF), and wherein the ELR-SIG field immediately follows the ELR-LTF.

17. A method for wireless communication at a wireless communication device, comprising:
receiving, via a version independent portion of a universal signal (U-SIG) field of a physical layer (PHY) protocol data unit (PPDU), a version identifier subfield indicative of a version associated with the PPDU; and
parsing a version dependent portion of the U-SIG field of the PPDU in accordance with the version associated with the PPDU, the version dependent portion of the U-SIG field comprising at least a first indication that the PPDU is associated with an enhanced long range (ELR) format and a second indication of a first station (STA) identifier associated with the PPDU.

18. The method of claim 17, wherein:
the version dependent portion of the U-SIG field comprises a PPDU type and compression mode subfield,
the PPDU type and compression mode subfield comprises the first indication that the PPDU is associated with the ELR format in accordance with the version associated with the PPDU,
the PPDU type and compression mode subfield comprises a plurality of bits,
the first indication that the PPDU is associated with the ELR format corresponds to a codepoint indicated by the plurality of bits, and
the codepoint corresponds to a value of three.

19. The method of claim 17, wherein:
the version identifier subfield comprises three bits indicative of a codepoint corresponding to a value of one, and
the codepoint corresponding to the value of one indicates that the version associated with the PPDU is ultra-high reliability (UHR).

20. The method of claim 17, wherein:
the version dependent portion of the U-SIG field includes a STA identifier subfield in accordance with the version associated with the PPDU,
the STA identifier subfield includes the second indication of the first STA identifier associated with the PPDU, and
the first STA identifier corresponds to an addressed receiver of the PPDU.
